(19) United States
(12) Patent Application Publication
(10) Pub. No.: US 2014/0298802 A1
(43) Pub. Date: Oct. 9, 2014

(54) Control Device for Internal Combustion Engine

(71) Applicant: Hitachi Automotive Systems, Ltd., Hitachinaka-shi, Ibaraki (JP)

(72) Inventors: Kunihiko Suzuki, Tokyo (JP); Seiji Asano, Hitachinaka (JP)

(73) Assignee: Hitachi Automotive Systems, Ltd., Hitachinaka-shi, Ibaraki (JP)

(21) Appl. No.: 14/356,335

(22) PCT Filed: Oct. 31, 2012
(86) PCT No.: PCT/JP2012/078093

§ 371 Date: May 5, 2014

(30) Foreign Application Priority Data
Nov. 25, 2011 (JP) 2011-257036

(51) Int. Cl. F02B 37/22

(52) U.S. Cl. CPC F02B 37/22
USPC 60/602

(57) ABSTRACT

In internal combustion engines that return exhaust gas branching from downstream section of a turbine to an upstream section of a compressor during exhaust gas return in a supercharged state, the present invention closes an air bypass valve that bypasses the compressor while the vehicle is decelerating, and also opens a wastegate valve that bypasses or diverts gases away from the turbine in order to resolve a phenomenon in which the amount of exhaust gas temporarily increases and the exhaust gas cannot be supplied at a stable target value while the vehicle is decelerating due to the length of the path from the convergence section where the new air meets the EGR, to the cylinder, and due to the opening of the air bypass valve of the air bypass path joining the top and bottom of the compressor during deceleration.

### TECHNICAL FIELD

The present invention relates to a control device for internal combustion engines that circulates exhaust gas branched from downstream section of the exhaust side turbine after cooling by a cooler, to the upstream section of the intake side compressor, and relates in particular to a control device for internal combustion engines to control the exhaust gas flow rate so as to circulate an appropriate exhaust gas flow during transient driving operation of internal combustion engine.

### BACKGROUND ART

Among recent internal combustion engines, a technology known for internal combustion engines utilizing a supercharger such as for pressurizing the air supplied to the internal combustion engine from the viewpoints of downsizing, low fuel consumption, and low exhaust gas emissions is disclosed in Japanese Unexamined Patent Application Publication No. 2009-250209 (patent document 1).

A technology is disclosed in patent document 1 for internal combustion engines containing a variable valve train mechanism and a supercharger, in which a first exhaust gas return flow path is formed to supply exhaust gas branched from the upstream section of the exhaust side turbine (hereafter called turbine) to an intake side compressor (hereafter called compressor), and a second exhaust gas return flow path is formed to supply exhaust gas to the downstream side of the compressor, and a control valve adjusts the upstream side exhaust gas quantity and downstream side exhaust gas quantity so that a target exhaust gas return flow quantity that is set according to the operation state is obtained.

### CITATION LIST

### Patent Literature

Patent literature 1: Japanese Unexamined Patent Application Publication No. 2009-250209

### SUMMARY OF INVENTION

### Technical Problem

However, in structures in conventional internal combustion engines containing a supercharger to circulate exhaust gas to the upper section of the compressor, a phenomenon occurred in which the exhaust gas could not be supplied at a stable target value during temporary increases or decreases in the exhaust gas during transient operation such as during vehicle decelerating or accelerating due to causes such as a long path to the cylinder from the section where the new air converges with the exhaust gas, and to opening the air bypass valve in the air bypass path joining the top and bottom of the compressor. Therefore, due to incorrect circulation of exhaust gas, problems such as worsening of the exhaust due to variations in the air-fuel ratio or fluctuations in torque, or in the worst case misfires occurred

The present invention has the object of providing a control device for internal combustion engines capable of controlling exhaust gas input into the cylinder at a target value with good accuracy during transient operation of internal combustion engine.

### Solution to Problem

In internal combustion engines that circulates exhaust gas branched from the downstream section of the turbine after cooling by a cooler, to the upstream section of the intake side compressor a feature of the present invention is that the air bypass valve for bypassing air to the compressor is set to the closed state during deceleration or acceleration in a state where circulating exhaust gas while the internal combustion engine is in a supercharging state.

### Advantageous Effects of Invention

The present invention is capable of suppressing temporary increases or decreases in exhaust gas during supercharging, and preventing torque fluctuations, and the worsening of the exhaust accompanying fluctuations in the air-fuel ratio.

### BRIEF DESCRIPTION OF DRAWINGS

FIG. 1 is a structural drawing for showing the entire structure of the control system for internal combustion engine in the present invention;

FIG. 2 is a characteristic diagram for describing the steady-state target opening map for the throttle valve and the wastegate valve of the internal combustion engine;

FIG. 3 is a characteristic diagram for describing the relation between the exhaust gas return flow control valve opening and the exhaust gas return flow rate; and the relation between charging efficiency and the throttle valve opening;

FIG. 4 is a characteristic diagram for describing the respective time transitions for the degree of opening, intake pressure, charging efficiency, and exhaust gas return flow rate of each of the throttle valve, exhaust gas return flow control valve, air bypass valve, and wastegate valve when accelerated from operating point B to operating point A in the characteristic diagram shown in FIG. 2;

FIG. 5 is a characteristic diagram for describing the respective time transitions for the degree of opening, intake pressure, charging efficiency, and exhaust gas return flow rate of each of the throttle valve, exhaust gas return flow control valve, air bypass valve, and wastegate valve when decelerated from operating point A to operating point B in the characteristic diagram shown in FIG. 2;

FIG. 6 is a characteristic diagram for describing the respective time transitions for the degree of opening, intake pressure, charging efficiency and exhaust gas return flow rate of each of the throttle valve, exhaust gas return flow control valve, air bypass valve, and wastegate valve at a sudden stop from operating point A to operating point C in the characteristic diagram shown in FIG. 2;

FIG. 7 is a characteristic diagram for describing the valve lift pattern of the intake valves and exhaust valves containing the phase varying mechanism for the intake valve and exhaust valve;

FIG. 8 is a characteristic diagram for describing the valve lift pattern of the intake valves containing the lift varying mechanism for the intake valve;

FIG. 9 is a characteristic diagram for describing the relation between the charging efficiency and the intake valve operating angle, and the intake valve operating angle correction amount during supply of exhaust gas;

FIG. 10 is a characteristic diagram for describing the lift and phase varying mechanism for the internal combustion engine, and the steady-state target opening map for the wastegate valve;

FIG. 11 is a structural diagram for describing the control block for processing each of the control command values for the lift and phase varying mechanism, exhaust gas return flow control valve, wastegate valve, ignition timing, and fuel injection in the characteristic diagram in FIG. 10;

FIG. 12 is a structural diagram for describing the control block for processing the charging efficiency, exhaust gas return flow rate, and intake pressure based on the throttle valve opening, exhaust gas return flow control valve opening, air flow sensor detection flow rate, before-and-after pressure states of the exhaust gas return flow control valve, the atmospheric status, and lift and phase varying mechanism position in the characteristic diagram in FIG. 10;

FIG. 13 is a flow chart for describing the respective operation of the intake valve operation angle, exhaust gas return flow control valve, air bypass valve, and wastegate valve when in the supercharging zone where cooled exhaust gas is supplied when decelerating from the operating point A to the operating point B and operating point C in the characteristic diagram in FIG. 10;

FIG. 14 is a characteristic diagram for describing the time transitions for the intake valve operating angle, the respective degree of opening of exhaust gas return flow control valve, air bypass valve, and wastegate valve, intake pressure, charging efficiency, and exhaust gas return flow rate when decelerated from operating point A to operating point B in the characteristic diagram shown in FIG. 10;

FIG. 15 is a characteristic diagram for describing the time transitions for the intake valve operating angle, the respective degree of opening of exhaust gas return flow control valve, air bypass valve, and wastegate valve, intake pressure, charging efficiency, and exhaust gas return flow rate when a sudden stop was made from operating point A to operating point C in the characteristic diagram shown in FIG. 10;

FIG. 16 is a flow chart for describing the respective operation of the intake valve operation angle and wastegate valve when in the supercharging zone and with cooled exhaust gas is supplied when accelerated from the operating point B to the operating point A in the characteristic diagram in FIG. 10;

FIG. 17 is characteristic diagram for describing the time transitions for the intake valve operation angle, the respective degree of opening of the exhaust gas return flow control valve, air bypass valve, and wastegate valve, intake pressure, charging efficiency, and exhaust gas return flow rate when accelerated from the operating point B to the operating point A in the characteristic diagram in FIG. 10;

FIG. 18 is a characteristic diagram for describing the steady-state target opening map for the throttle valve and the wastegate valve of the internal combustion engine;

FIG. 19 is a characteristic diagram for describing the relation between the charging efficiency and wastegate valve opening, and the wastegate valve opening correction amount during EGR supply;

FIG. 20 is a structural diagram for describing the control block for processing the respective control command values for the throttle valve, exhaust gas return flow control valve, wastegate valve, ignition timing, and fuel injection in the characteristic diagram of FIG. 18;

FIG. 21 is a flow chart for describing the respective operation of the throttle valve, exhaust gas return flow control valve, air bypass valve, and wastegate valve, and intake-exhaust valve varying mechanism when in the supercharging zone and with cooled exhaust gas supplied when decelerating from the operating point A to the operating point B, the operating point C, and the operating point Din the characteristic diagram in FIG. 18;

FIG. 22 is a characteristic diagram for describing the time transitions for the respective degree of opening of the throttle valve, exhaust gas return flow control valve, air bypass valve, and wastegate valve, intake pressure, charging efficiency, and exhaust gas return flow rate when decelerated from the operating point A to operating point B in the characteristic diagram in FIG. 18;

FIG. 23 is a characteristic diagram for describing the time transitions of the respective degree of opening of the throttle valve, exhaust gas return flow control valve, air bypass valve, and wastegate valve, intake pressure, charging efficiency, and exhaust gas return flow rate at a sudden stop from operating point A to operating point D in the characteristic diagram shown in FIG. 18;

FIG. 24 is a characteristic diagram for describing the time transitions for the respective degree of opening of the throttle valve, exhaust gas return flow control valve, intake-exhaust valve phase, intake pressure, charging efficiency, and exhaust gas return flow rate when decelerated from the operating point A to the operating point C in the characteristic diagram shown in FIG. 18;

FIG. 25 is a flow chart for describing each operation of the throttle valve and the wastegate valve when in the supercharging zone and with cooled exhaust gas supplied when accelerated from the operating point B to the operating point A in the characteristic diagram in FIG. 18; and

FIG. 26 is a characteristic diagram for describing the time transitions for the respective degree of opening of the throttle valve, the exhaust gas return flow rate control valve, the air bypass valve, and the wastegate valve, intake pressure, charging efficiency, and exhaust gas return flow rate when accelerated from the operating point B to the operating point A in the characteristic diagram in FIG. 18.

### DESCRIPTION OF EMBODIMENTS

The embodiments of the control device for internal combustion engines of the present invention are hereafter described in detail while referring to the drawings however there are plural embodiments so a common system structure for the internal combustion engines is first of all described.

### First Embodiment

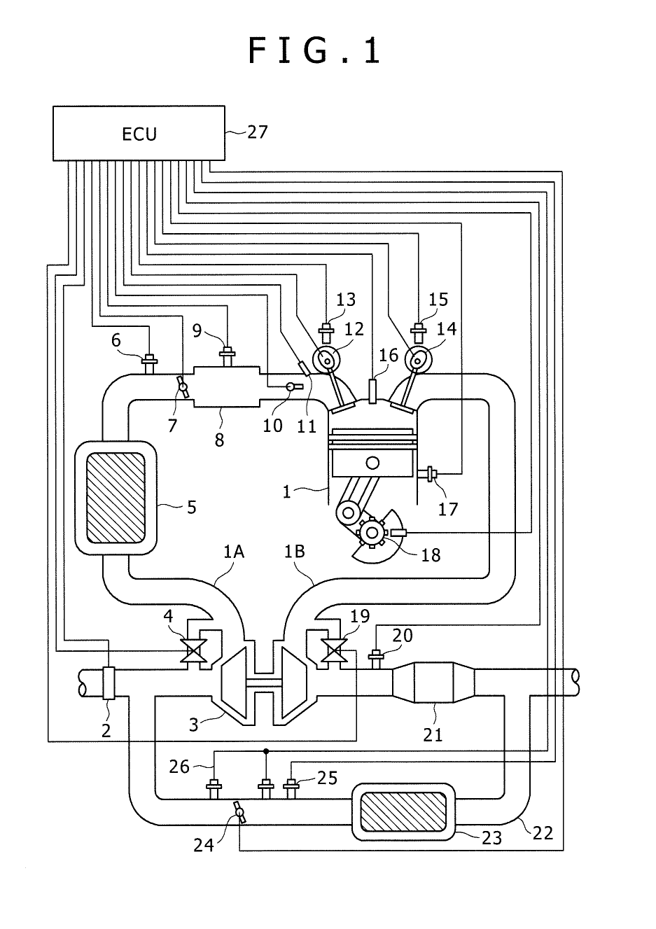

In FIG. 1, the reference numeral 1 denotes an internal combustion engine that is the object for control, and the intake flow path 1A and exhaust flow path 1B connecting in the internal combustion engine 1.

An air flow sensor 2 containing an intake air temperature sensor is installed in the intake valve flow path 1A. A turbo-type supercharger 3 is mounted in the intake flow path 1A and exhaust flow path 1B, and a compressor for the supercharger 3 is coupled to the intake flow path 1A, and a turbine is coupled to the exhaust flow path 1B.

The supercharger 3 includes a turbine for converting the energy within the exhaust gas into the rotating movement of the turbine blades, and a compressor for compressing the intake air by way of the rotation of the compressor blades coupled to the turbine blades. An intercooler for cooling the intake temperature that rose during adiabatic compression is mounted downstream at the compressor side of the supercharger 3.

An intake air temperature sensor 6 is mounted downstream of the intercooler 5 for measuring the intake air temperature after cooling. A throttle valve 7 for controlling intake air quantity flowing into the constriction cylinder constricting the flow path cross sectional area of the intake valve flow path 1A is mounted downstream of the intake air temperature sensor 6.

A throttle valve 7 is an electronically controlled type throttle valve for controlling the throttle opening independently of the accelerator (pedal) depressing force. An intake manifold 8 is coupled to the downstream side of the throttle valve 7. A structure may also be utilized in which the intercooler is integrated into one piece to the intake manifold downstream of the throttle valve 7. The volume from downstream of the compressor to the cylinder can in this way be reduced, and the acceleration-deceleration responsiveness can be improved.

A boost pressure sensor 9 is mounted to the intake manifold 8. A flow strengthening valve 10 for intensifying the turbulence of the cylinder interior flow by generating an eccentric flow in the intake air, and a fuel injection valve 11 to inject fuel into the intake port are mounted downstream of the intake manifold 8. The fuel injection method may also be a method that directly injects fuel into the cylinder.

The internal combustion engine 1 contains a phase varying mechanism respectively in the intake valve 12 and the exhaust valve valve 14 to consecutively vary the opening-closing phase of the intake valve 12 and exhaust valve 14. The intake valve 12 also includes a lift varying mechanism to consecutively vary that lift. The varying mechanism within the intake valve 12 and exhaust valve 14 includes the sensors 13 and 15 for detecting the opening-shutting phase of the valves, and are mounted in the intake valve 12 and exhaust valve 14.

A spark plug 16 to ignite a combustible gas mixture by sparks at an electrode section exposed within the cylinder is mounted in the cylinder head section. Moreover, a knock sensor 17 to detect knocking that occurs is installed in the cylinder.

A crank angle sensor 18 is mounted on the crankshaft. The revolution speed of the internal combustion engine 1 can be detected based on the signal output from the crank angle sensor 18. An air-fuel sensor 20 is mounted in the exhaust flow path 1B, and feedback control is implemented so that the fuel injection quantity supplied from the fuel injection valve 11 reaches the target air-fuel ratio based on the detection results from the air-fuel sensor 20.

An exhaust cleansing catalyst 21 is installed downstream of the air-fuel sensor 20, and purifies toxic exhaust gas components such as carbon monoxide, nitrous oxides, and non-combusted hydrogen by way of a catalytic reaction.

The supercharger 3 contains an air bypass valve 4 and a wastegate valve 19. The air bypass valve 4 is provided to prevent the pressure from the downstream section of the compressor to the upstream section of the throttle valve 7 from rising excessively. When the throttle valve 7 has suddenly stopped during supercharging, the intake air (gas mixture of air and exhaust gas) from the compressor downstream section can be sent by reverse flow to the compressor upstream section by opening the air bypass valve 4 to lower the boost pressure.

The wastegate valve 19 on the other hand is installed to prevent an excessive supercharging level in the internal combustion engine 1. When the boost pressure detected by the boost pressure sensor 9 has reached a specified level, a rise in boost pressure can be maintained or prevented by opening the wastegate valve 19 to allow the exhaust gas to bypass the turbine.

An exhaust gas return flow path (hereafter called EGR passage) 22 is coupled to branch the exhaust gas from downstream of the exhaust cleansing catalyst 21 to return the exhaust gas flow to the upstream section of the compressor. The EGR passage 22 includes an exhaust gas cooler 23 to cool the exhaust gas.

An exhaust gas return flow control valve (hereafter called EGR valve) 24 is installed to control the exhaust gas flow quantity in the downstream of the exhaust gas cooler 23. A temperature sensor 25 is installed to detect the temperature of the exhaust gas in the upstream section of the EGR valve 24, and a differential pressure sensor 26 is installed to detect the difference in pressure before and after the EGR valve 24.

Each of these control elements are controlled by a control unit (hereafter called the ECU) 27. The above described sensor types and actuator types are coupled to the ECU 27. More specifically, the ECU 27 controls the throttle valve 7, fuel injection valve 11, the phase-lift varying mechanisms 13 and 15, and the EGR valve 24, etc.

Further, ignition can occur in the spark plug 16 at a timing determined by the ECU 27 according to the operating state detected as the internal combustion engine 1 operating status based on signals input by each of the above described sensor types.

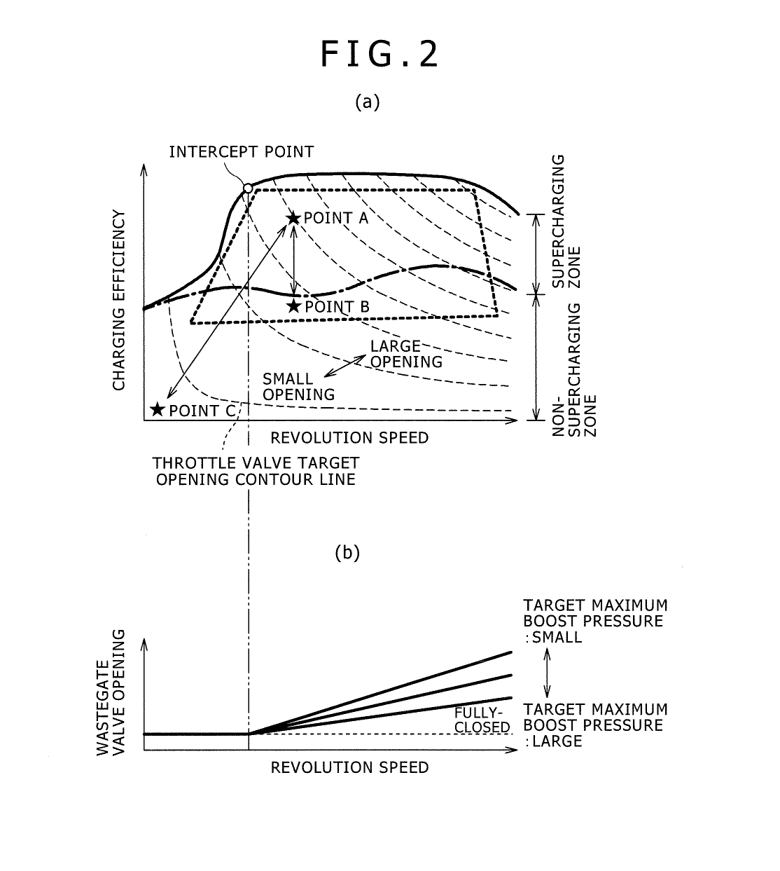

FIG. 2 is a diagram for describing the steady-state target opening map for the throttle valve 7 and the wastegate valve 19 of the internal combustion engine containing a supercharger. The target (degree of) opening of the throttle valve 7 is set to increase along with an increased in the intake air quantity. In this example, cooled exhaust gas (hereafter, called cooled-EGR) is supplied by way of the exhaust gas cooler 23 at a load reference level (region within the broken line in FIG. 2(a)) somewhat lower than the supercharging zone.

Here, the region enclosed by the thick broken line is returned exhaust gas or in other words the EGR region. (In the following drawings, the EGR regions are shown in the same way.)

In the related art, fuel enrichment was implemented in this region to reduce knocking and suppress a rise in the exhaust temperature; moreover low fuel consumption operation can be achieved by performing combustion at a stoichiometric ratio while supplying cooled-EGR to reduce knocking and suppress a rise in the exhaust temperature in this same region.

FIG. 2(b) shows the relation of the degree of opening of the wastegate valve 19 to the revolution speed, and in which the wastegate valve 19 performs boost pressure control at a revolution speed range at the intercept point or higher. The larger the target boost pressure at the same revolution speed, the larger the degree of opening set for the wastegate valve.

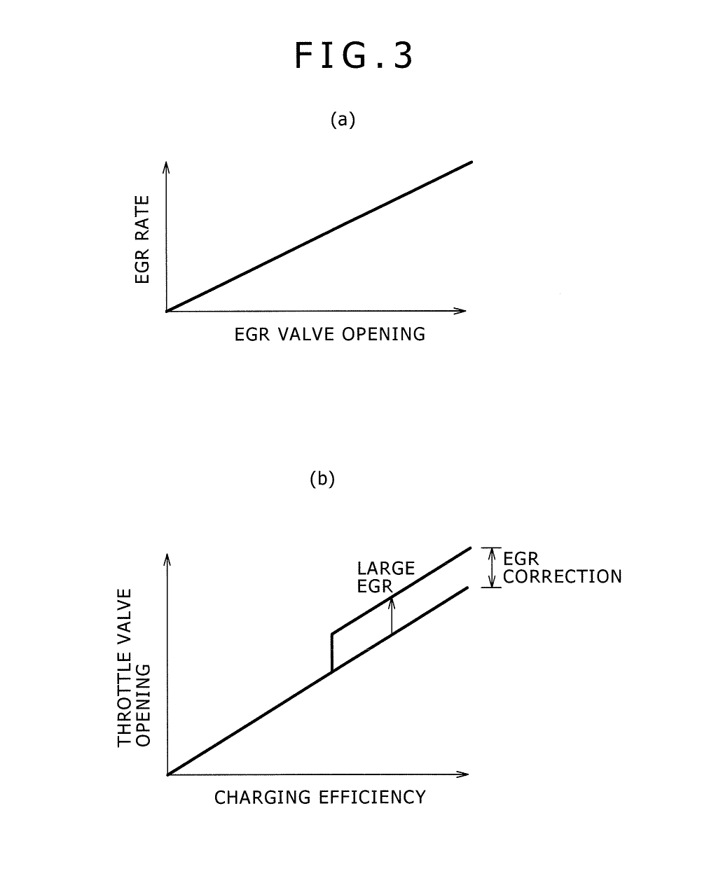

FIG. 3 is a diagram for describing the relation between the degree of opening of the EGR valve 24 and the exhaust gas return flow rate (hereafter called EGR rate); and the relation between the charging efficiency and the degree of opening of the throttle valve 7, as well as the degree of the opening correction quantity of the throttle valve 7 during the supply of exhaust gas. As shown in FIG. 3(a), at the same before and after difference in pressure in the EGR valve 24, the more the degree of opening of the EGR valve 24 is increased, the larger the tendency towards a large EGR rate.

As shown in FIG. 3(b), the more the increase in charging efficiency, the larger the degree of opening that must be set for the throttle valve 7. In this example, the exhaust gas meets (the new air) upstream of the throttle valve 7, and the degree of opening of the throttle valve 7 must be corrected to increase according to the supply of exhaust gas.

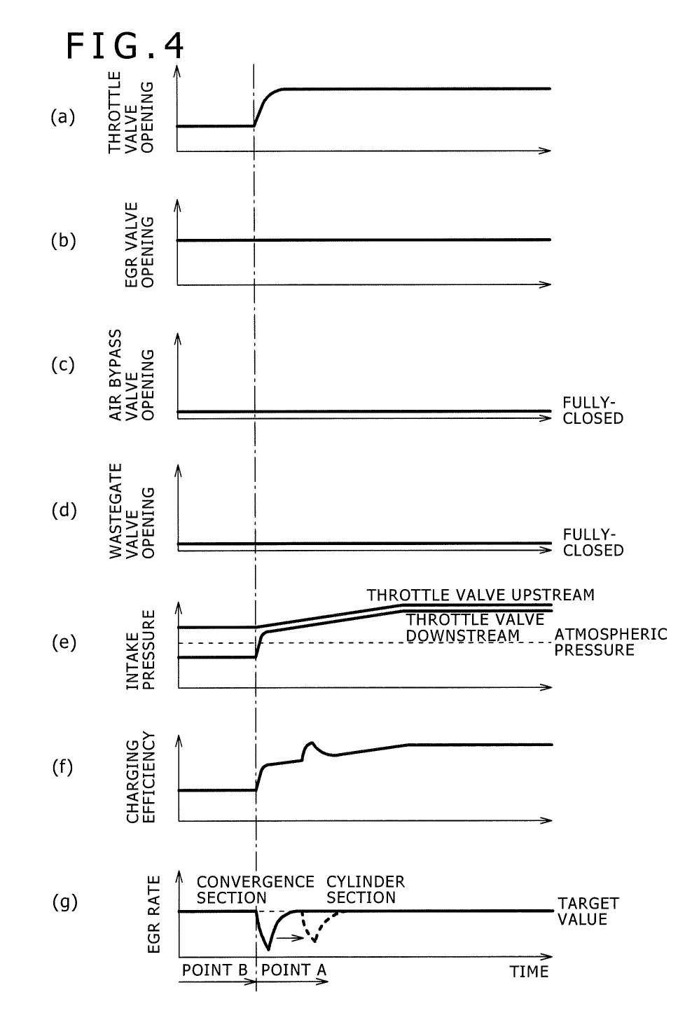

FIG. 4 is a diagram for describing the time transitions for the respective degree of opening of the throttle valve 7, EGR valve 24, air bypass valve 4, and wastegate valve 19, intake pressure, charging efficiency, and EGR rate when accelerated from operating point B to operating point A as shown in FIG. 2, in an internal combustion engine containing a supercharger of the related art.

In a state where the air bypass valve 4 and wastegate valve 19 are closed as shown in (c) and (d) of FIG. 4, and adjusting the load at operating point B by way of the throttle valve 7 as shown in FIG. 4(a), the effect from constriction by the throttle valve 7 on compression of intake air by the supercharger 3, creates a large difference in before and after pressure in the throttle valve 7. Suddenly opening the throttle valve 7 from this state while clamping the target EGR rate, causes an inflow of new air all at once to downstream of the throttle valve 7, reduces the before and after difference in pressure in the throttle valve 7 as shown in FIG. 4(e), and the charging efficiency also fluctuates as shown in FIG. 4(f).

At this time, a temporary spike phenomenon occurs as shown in FIG. 4(g) that drastically lowers the EGR rate in the EGR convergence section. A spike with this type of EGR rate reaching the cylinder causes the problems of deterioration in air-fuel ratio control accuracy and deterioration in torque control accuracy.

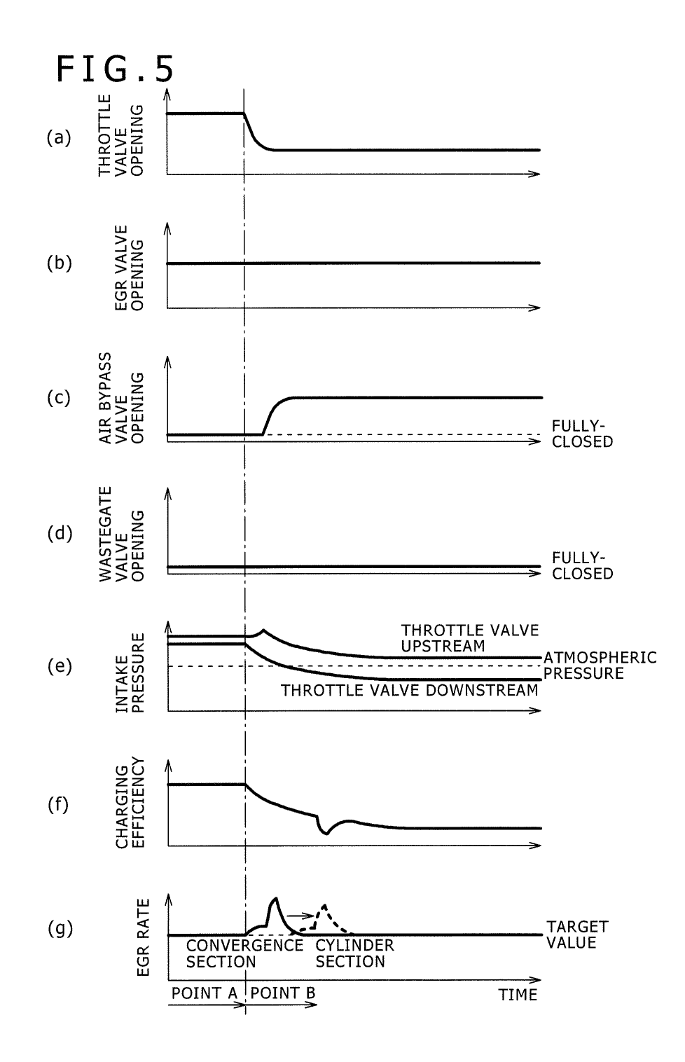

FIG. 5 is in the same way, a diagram for describing the time transitions for the respective degree of opening of the throttle valve, EGR valve, air bypass valve, and wastegate valve, intake pressure, charging efficiency, and EGR rate when decelerated from the operating point A to the operating point B in the control system for internal combustion engines containing a supercharger of the related art. In FIG. 5, a change and a reverse change occur as shown in FIG. 4.

When the throttle valve 7 suddenly stops, the intake air in the compressor downstream section (throttle valve upstream section) has no place to go, and the boost pressure suddenly starts to rise. An unstable phenomenon known as surging occurs when the compressor suddenly enters an operating region with a low flow rate and high boost pressure.

To prevent this phenomenon, in internal combustion engines containing superchargers of the related art, the compressed gas is sent back to the compressor upstream section by opening the air bypass 4 valve utilizing the before and after pressure difference in throttle valve 7 as the drive source.

However, along with the above described operation to open the air bypass valve 4, a gas mixture of air and exhaust gas flows in reverse to the upstream section from the EGR convergence section which is the section coupling the EGR passage 22 with the intake flow path 1A, and then passes through the EGR convergence section and when flowing in the cylinder side sequential flow direction, the gas mixture containing the new EGR flows to the cylinder side.

Therefore, a spike phenomenon temporarily occurs as shown in FIG. 5(g) in which the EGR rate in the EGR convergence section drastically increases. When this type of spike in the EGR rate reaches the cylinder, the problems of deterioration in air-fuel ratio control accuracy and deterioration in torque control accuracy occur.

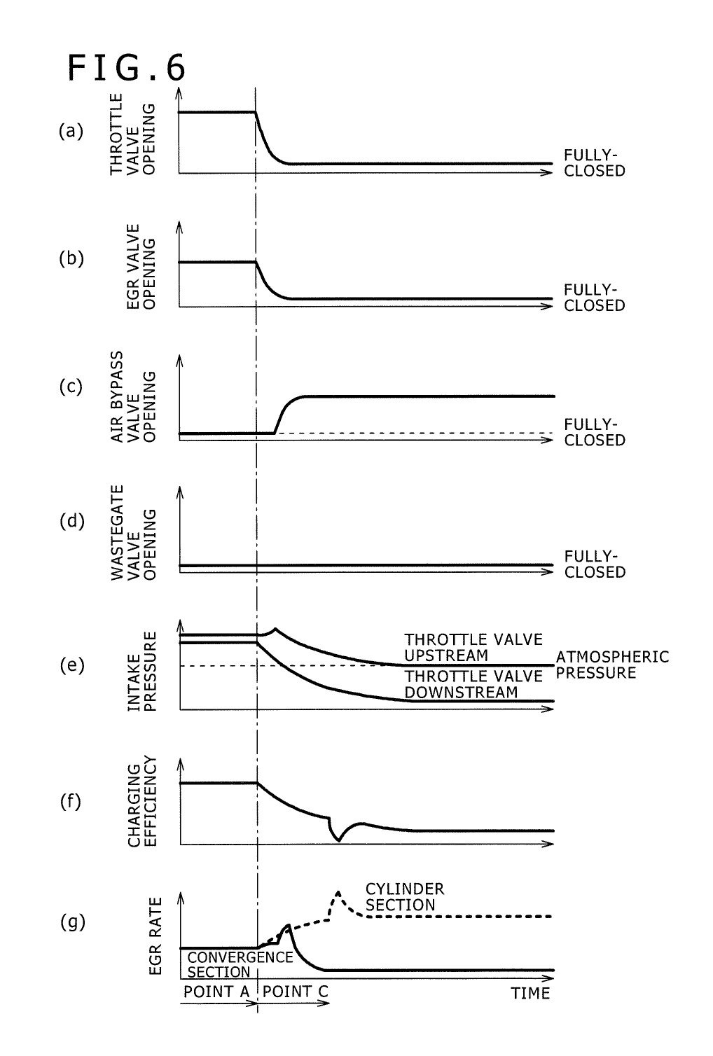

FIG. 6 is a diagram for describing the time transitions for the respective degree of opening of the throttle valve, EGR valve, air bypass valve, and wastegate valve, intake pressure, charging efficiency, and exhaust gas return flow rate when there is a sudden stop from operating point A to operating point C in the control system for internal combustion engine containing a supercharger of the related art.

When the throttle valve 7 suddenly stops, the intake air in the compressor downstream section (throttle valve upstream section) has no place to go, and the boost pressure suddenly starts to rise as in FIG. 5. The air bypass valve 4 starts to open when the difference in before and after pressure in the throttle valve 7 becomes large, and gas containing EGR flows in reverse from the compressor downstream section to the upstream section.

Even in cases where the EGR valve 24 suddenly stops in synchronization with the throttle valve 7, there is a fixed delay until the EGR accumulated in the space from a downstream section of the EGR convergence section to the cylinder reaches the cylinder, so that the percentage of internal EGR within the cylinder increases due to a drop in pressure in the downstream section of the throttle valve 7 during that time. The superimposing of accumulated EGR on the internal EGR results in a large supply of EGR in the cylinder, causing the problem of misfires to occur.

The above description is the mechanism causing a temporary increase or decrease in the exhaust gas due to transient operation in the internal combustion engine containing a supercharger of the related art.

Next, before describing the embodiment of the present invention, the lift and phase varying mechanism utilized in the embodiment of the present invention is described.

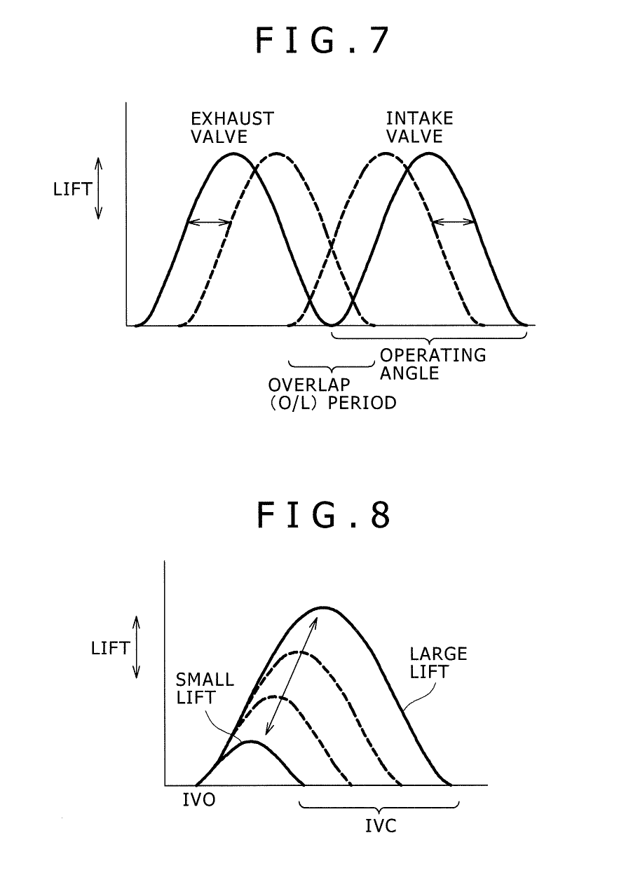

FIG. 7 is a diagram for describing the valve lift pattern when a phase varying mechanism was mounted in the intake valve 12 and the exhaust valve 14.

When the phase of the intake valve 12 is varied to the advance angle side, and conversely the phase of the exhaust valve is varied to the delay angle side, there is an increase in the overlap period of the intake valve 12 and the exhaust valve 14. In internal combustion engines containing this type of phase varying mechanism, the intake valve 12 and the exhaust valve 14 are regulated so that an overlap period occurs in the partial load conditions, and the exhaust gas in the exhaust pipes is blown back all at once to the intake pipe so that internal EGR can be generated. The phase of the intake valve 12 and the exhaust valve 14 are both set to a delay angle from the upper dead center, and by increasing the cylinder volume in the period where the exhaust valve is closed, the residual gas within the cylinder can be increased. Utilizing this method allows generating an internal EGR without increasing the overlap period of the intake valve and the exhaust valve.

The pump loss under partial load conditions can be reduced along with the increase in internal EGR, and the combustion gas temperature can also be lowered so that the nitrogen oxide compounds within the exhaust gas can be reduced.

FIG. 8 is a diagram for describing the valve lift pattern of the intake valve 12 containing the lift varying mechanism for intake valve 12. In internal combustion engines where the intake valve 12 controls the charging efficiency, a negative pressure is generated due to constriction of the upstream pressure of intake valve 12 by the throttle valve 7 so that the problem of poor fuel consumption occurs due to pump loss.

Therefore, if the intake quantity could be regulated by the lift from the intake valve 12 as shown in FIG. 8, without constriction of the upstream pressure of intake valve 12 by the throttle valve 7, then the poor fuel consumption accompanying the above described pump loss could be suppressed.

Therefore, utilizing a combination of a lift varying mechanism to consecutively vary the valve lift of the intake valve 12 by way of the lift varying mechanism such as shown in FIG. 8, and a phase varying mechanism to consecutively vary the phase, allows varying the intake valve closed period (IVC) along with clamping the intake valve open period (IVO). By providing this type of variable mechanism, the charging efficiency can be regulated without the throttle valve 7.

This lift varying mechanism includes a relation to increase the maximum lift according to the increase in the operating angle of the intake valve 12, and is capable of advancing the intake valve closed period (IVC) to reduce the intake quantity simultaneous with reducing the lift quantity when the required torque is small. By advancing the angle of the intake valve closed period (IVC) at this time, a relatively small reduction can be made in the piston compression quantity compared to the piston expansion quantity so that along with reducing the pump loss, improvement of the fuel consumption is also expected by way of the Mirror cycle effect.

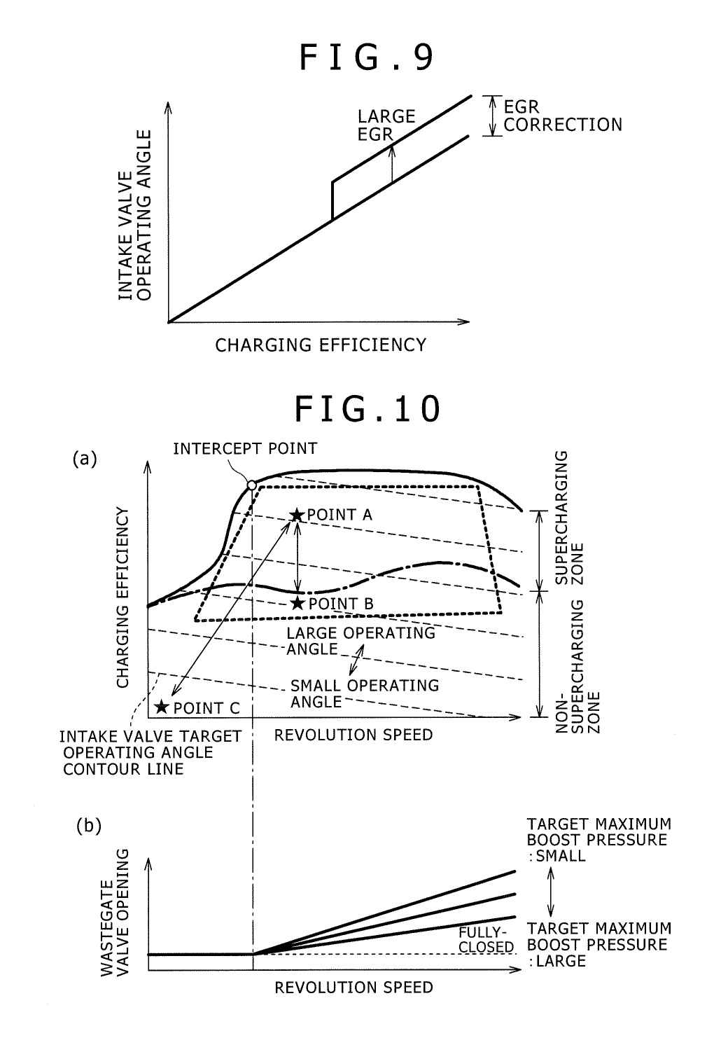

FIG. 9 is a diagram for describing the relation between the charging efficiency and the intake valve 12 operating angle, and operating angle correction amount of the intake valve 12 during the supply of exhaust gas. As shown in the same figure, the more the increase in charging efficiency, the larger the setting required for the intake valve operating angle. In this example, obtaining the same charging efficiency requires correction of the operating angle of the intake value 12 to increase side according to the supply of exhaust gas.

FIG. 10 is a diagram for describing the lift and phase varying mechanism utilized instead of the throttle valve 7 shown in FIG. 2, and for describing the steady-state target opening map for the wastegate valve 19 in internal combustion engines containing a supercharger.

The operation of the lift and phase varying mechanism increases the operating angle of the intake valve 12 as the charging efficiency increases the same as in FIG. 2. In this example however, cooled exhaust gas is supplied by way of the exhaust gas cooler 23 at a load reference level (region within the broken line in FIG. 10(a)) somewhat lower than the supercharging zone. The EGR region is therefore within the broken lines.

In the related art, fuel enrichment was implemented in this region to reduce knocking and suppress a rise in the exhaust temperature; however low fuel consumption operation can be achieved by performing combustion at a stoichiometric ratio while supplying cooled-EGR to reduce knocking and suppress a rise in the exhaust temperature in this same region.

FIG. 10(b) shows the relation of the degree of opening of the wastegate valve 19 to the revolution speed, and in which the wastegate valve 19 performs boost pressure control at a revolution speed range at the intercept point or higher. The larger the target boost pressure at the same revolution speed, the larger the degree of opening set for the wastegate valve 19.

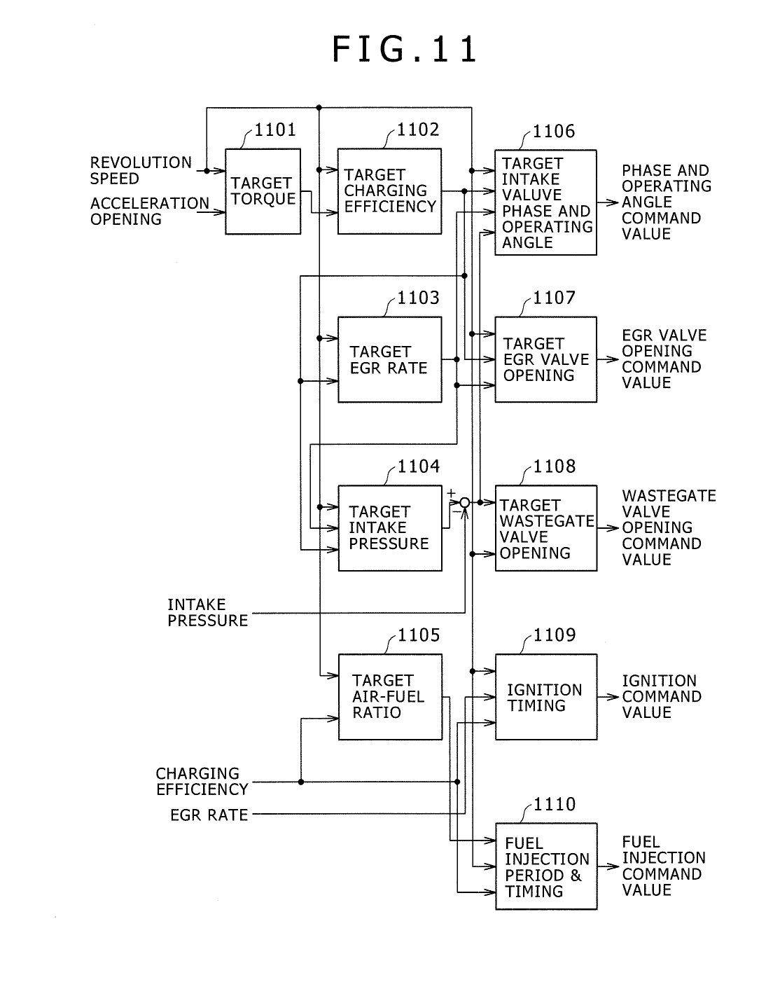

FIG. 11 shows the control block for the control device mounted in ECU 27, and shows the block processing of each of the control command values for the lift and phase varying mechanism, EGR valve 24, wastegate valve 19, spark plug 16, and fuel injection valve 11.

In FIG. 11, the control quantities are mainly calculated in stage 1, and the block 1101 calculates the target torque based on the revolution speed and acceleration degree of opening (=foot pressure quantity), and the block 1102 calculates the target charging efficiency based on the revolution speed and the target torque, and the block 1103 calculates the target EGR rate based on the revolution speed and the target charging efficiency, and the block 1104 calculates the target intake pipe pressure based on the target charging efficiency and the target EGR rate, and the block 1105 calculates the target air-fuel ratio based on the revolution speed and the charging efficiency.

The specific physical quantities are next calculated in stage 2 based on the control quantities so the block 1106 calculates the target intake valve phase and operating angle based on the revolution speed, target charging efficiency, target EGR rate, and difference between the target intake pressure and current intake pressure, the block 1107 calculates the target EGR valve (degree of) opening based on the revolution speed, target charging efficiency, and target EGR rate, the block 1108 calculates the target wastegate valve (degree of) opening based on the revolution speed and difference between the target intake pressure and current intake pressure, the block 1109 calculates the ignition timing based on the revolution speed and current charging efficiency and current EGR rate, and the block 1110 calculates the fuel injection period and fuel injection timing based on the revolution speed and current charging efficiency and target air-fuel ratio.

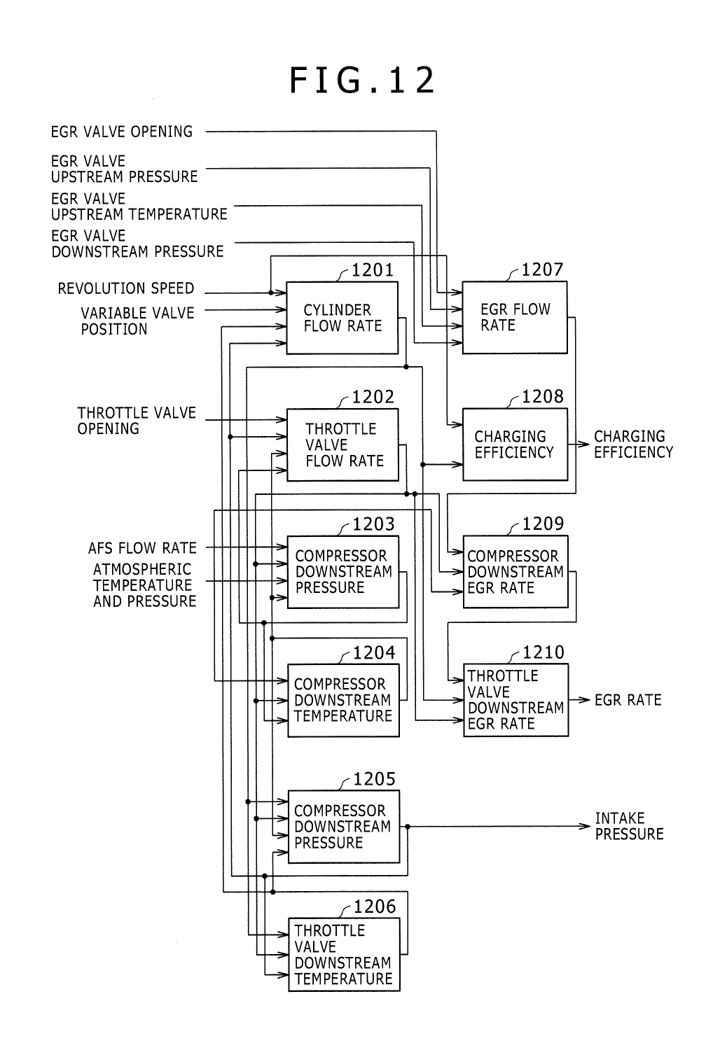

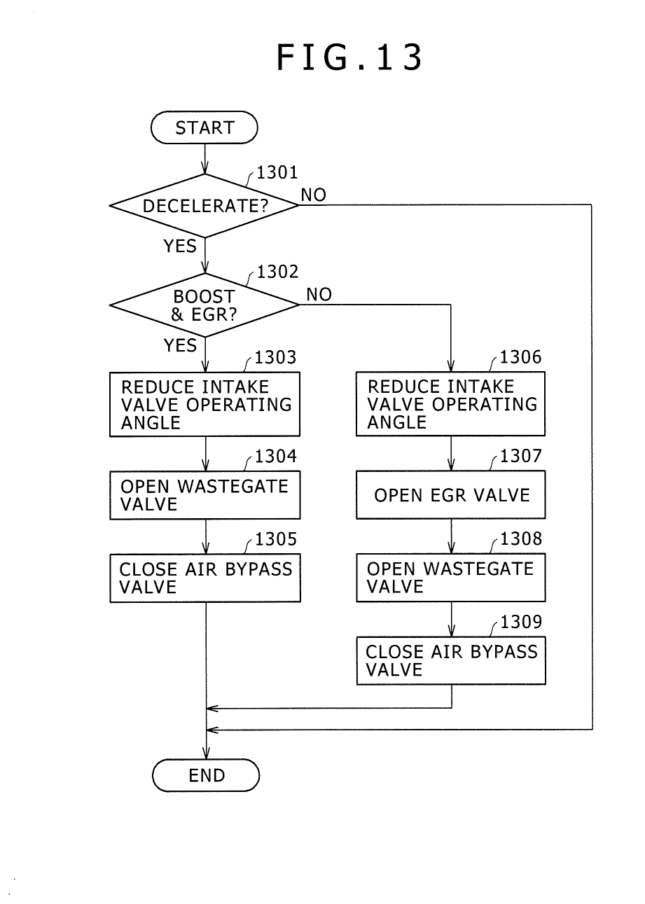

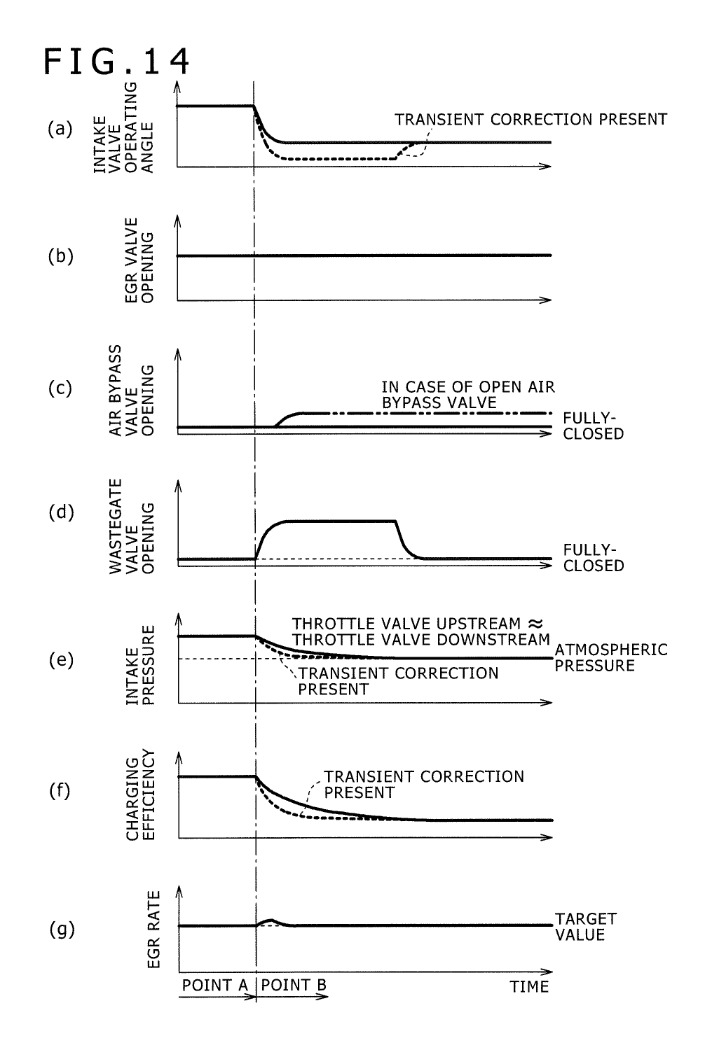

FIG. 12 also shows the control block for the control device mounted in ECU 27, and shows the control block for calculating the parameters used for controlling the charging efficiency, EGR rate, and intake pressure and so on based on the detection signals for the throttle valve degree of opening, EGR valve degree of opening, air flow sensor detection flow rate, EGR valve before-and-after pressure state, atmospheric state, position of intake valve or exhaust valve, etc.

In FIG. 12, the block 1201 calculates the cylinder flow rate based on the revolution speed, the variable valve position, throttle valve downstream pressure, and throttle valve downstream temperature.

The block 1202 calculates the throttle valve flow rate based on the throttle valve degree of opening, throttle valve upstream pressure, throttle valve downstream pressure, and throttle valve upstream temperature.

The block 1203 calculates the compressor downstream pressure based on the air flow sensor detection flow rate, the throttle valve flow rate, the atmospheric temperature, the atmospheric pressure, and the compressor downstream temperature.

The block 1204 calculates the compressor downstream temperature based on the air flow sensor detection flow rate, throttle valve flow rate, and compressor downstream pressure.

The block 1205 calculates the throttle valve downstream pressure based on the throttle valve flow rate, cylinder flow rate, compressor downstream temperature, and throttle valve downstream temperature

The block 1206 calculates the throttle valve downstream temperature based on the throttle valve flow rate, cylinder flow rate, and compressor downstream temperature. The block 1207 calculates the EGR flow rate based on the EGR valve degree of opening, EGR valve upstream pressure, EGR upstream temperature, and EGR valve downstream pressure.

The block 1208 calculates the charging efficiency based on the revolution speed and cylinder flow rate. The block 1209 calculates the compressor downstream EGR rate based on the EGR flow rate, throttle valve flow rate, and air flow sensor detection flow rate.

The block 1210 calculates the throttle valve downstream EGR rate based on the compressor downstream EGR rate, throttle valve flow rate, and cylinder flow rate.

The intake pressure calculated by block 1205, the charging efficiency calculated by block 1208, and the EGR rate calculated by block 1,210 can be utilized in the control shown in FIG. 11.

In the control device for internal combustion engines including this type of ECU 27, the embodiment of the present invention for resolving the problem of a temporary increase or decrease in the exhaust gas flow rate during transient operation is described next.

FIG. 13 is a flow chart for describing the respective operation of the intake valve operation angle, EGR valve 24, air bypass valve 4, and wastegate valve 19 when in the supercharging zone and with cooled-EGR supplied, and deceleration is made from the operating point A to the operating point B in the example shown in FIG. 10.

The flow chart (operation) shown in FIG. 13, is executed by the control block shown in FIG. 11 and FIG. 12. The flow chart operation in FIG. 13 starts up when an execution command is input by interrupt processing by a specified time interruption.

When this interrupt is input, the current driving status is judged by the accelerator pedal position in step 1301. In the example in step 1301, the driving state is judged as a deceleration state when the accelerator degree of opening is small and the internal combustion engine is at high revs (rpm), and the interrupt process is terminated when judged as not a deceleration state.

When judged as a deceleration state in step 1301, the operation proceeds to step 1302 and the supercharger 3 operates in the current internal combustion engine state, and a decision is made on whether or not the region is the exhaust gas returned region. Namely, a decision is made on whether or not the target operating point is the supercharging zone and within the region where cooled-EGR is supplied.

When in the supercharging zone and within the region where cooled-EGR is supplied, the operation proceeds to step 1303 and the intake valve operating angle is reduced to constrict the intake quantity, and in this way decelerating operation is implemented.

The processing further proceeds to the subsequent step 1304, the wastegate valve 19 is opened, and the compressor rotation is reduced by by-passing the exhaust gas flowing in the turbine and reducing the number of turbine rotations.

Next, the processing proceeds to step 1305, the air bypass valve 4 that bypasses the compressor is closed, to suppress a reverse flow of the mixed gas including the compressor downstream exhaust gas.

The spike phenomenon from the temporary increase in exhaust gas seen during deceleration can in this way be prevented.

In step 1302 on the other hand, the supercharger 3 operates in this current state of the internal combustion engine, and when judged as a region for no exhaust gas return flow, the processing proceeds to step 1306, the intake valve operating angle is reduced to constrict the intake quantity, and in this way decelerating operation is implemented.

The processing further proceeds to step 1307, and in this operating region there is basically no exhaust return flow, so the EGR valve 24 is closed to stop the exhaust gas return flow.

Next the processing proceeds to step 1308, the wastegate valve 19 is opened and the compressor rotation is reduced by bypassing the flow of exhaust gas in the turbine to reduce the turbine rotations.

Next, the processing proceeds to step 1309, the air bypass valve 4 that bypasses the compressor is closed to restrict the reverse flow of the mixed gas including exhaust gas downstream of the compressor.

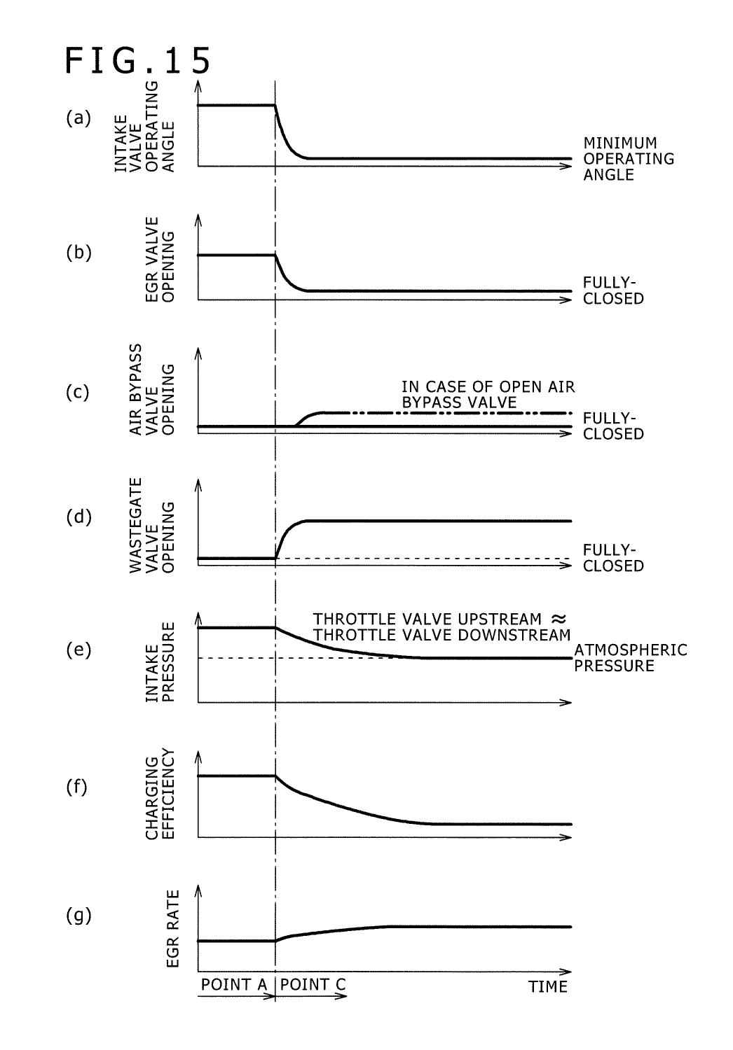

FIG. 14 is a characteristic diagram for describing the effect obtained by executing step 1303 through step 1305 in the flow chart shown in FIG. 13. The figure describes the time transitions for the operating angle of the intake valve 12, the respective degree of opening of EGR valve 24, air bypass valve 4, and wastegate valve 19, intake pressure, charging efficiency, and EGR rate when decelerated from operating point A to operating point B.

Along with executing deceleration control to reduce the intake valve operating angle instep 1303 as shown in FIG. 14(a), at essentially the same timing, the wastegate valve 19 is opened in step 1304 as shown in FIG. 14(a), and the air bypass valve #4 is maintained in the closed state in step 1305 as shown in in FIG. 14(c). Here, the EGR valve 224 is opened as shown in FIG. 14(b) to maintain a specified control status.

Therefore, as shown in FIG. 14(e), there is not a significantly large difference in before-and-after intake pressure in the throttle valve 7, the charging efficiency smoothly declines as seen in FIG. 14(f), and consequently the EGR rate stabilizes as seen in FIG. 14(g) with no large fluctuations.

An EGR reverse flow to upstream sections of the compressor can in this way be prevented by closing the air bypass valve 4 during deceleration, and the spike phenomenon that occurred in the related art due to a temporary increase in exhaust gas during deceleration as described in FIG. 5 as the example of the related art can be effectively prevented.

A surging reduction that occurs during a rise in surplus boost pressure under low flow rate conditions for the intake quantity to restrict the turbine revolution speed can also be prevented by opening the wastegate valve 19.

The surging can be even more thoroughly prevented by slightly opening the air bypass valve 4 to an extent where the flow does not reach the upstream side of the EGR convergence section by way of a reverse flow of exhaust gas at least after a specified time after the start of the wastegate valve 19 operation, as shown by the two-dot chain line in FIG. 14(c).

As shown by the dashed lines in FIGS. 14(a), (e), and (f), when judged that the intake pressure has not reached the target intake pressure, a temporary transient correction can be made to the target control quantity of the intake valve operating angle to the lower (reduction) side so that an improvement in deceleration response can also be expected.

FIG. 15 is a characteristic diagram for describing the effect obtained from executing step 1306 to step 1309 of the flow chart in FIG. 13. This figure describes the time transitions for the intake valve 12 operating angle, the respective degree of opening of EGR valve 24, air bypass valve 4, and wastegate 19 valve, intake pressure, charging efficiency, and EGR rate when a sudden stop was made from operating point A to operating point C in the example in FIG. 10.

After sudden deceleration, the processing proceeds to step 1302, and after deciding that the current internal combustion engine state is in the supercharging zone and is not in the zone where cooled-EGR is being supplied, the processing proceeds to step 1303 and the operating angle of the intake valve 12 is reduced to constrict the intake flow rate as shown in FIG. 15(a) to achieve decelerating operation.

Subsequently, the EGR valve 24 is closed as shown in FIG. 15(b) since the operating point C is not in the EGR region, and further the air bypass valve 4 is shifted to or maintained in a closed state as shown in FIGS. 15(c) and (d) to open the wastegate valve.

The before-and-after intake pressures of throttle valve 7 consequently become nearly equal as in FIG. 15(e), and the charging efficiency also smoothly stabilizes as in FIG. 15(f) and there is no temporary increase in the EGR rate in FIG. 15(g).

The return flow of exhaust gas to the upstream section of the compressor can in this way be prevented by setting the air bypass valve 4 to the closed state during deceleration. Also, the spike phenomenon occurring due to a temporary increase in exhaust gas during deceleration as described in FIG. 5 can be appropriately prevented.

Further, the turbine revolution speed can be kept low by opening the wastegate valve 19 to allow preventing the surging reduction that occurs during an excess rise in boost pressure under low flow rate conditions. Moreover, the surging can be prevented even more thoroughly by slightly opening the air bypass valve 4 to an extent where the reverse flow of exhaust gas does not reach the upstream side of the EGR convergence section at least after a specified time after the start of the wastegate valve 19 operation, as shown by the two-dot chain line.

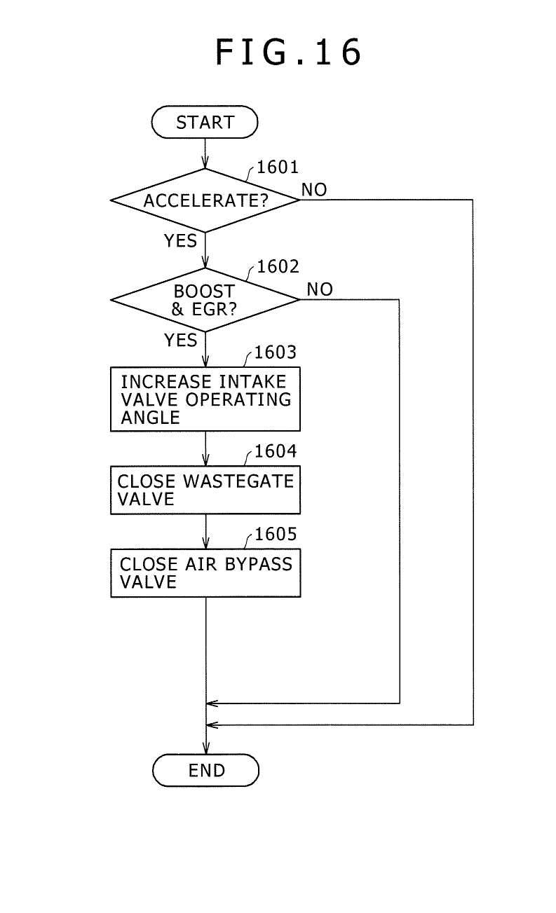

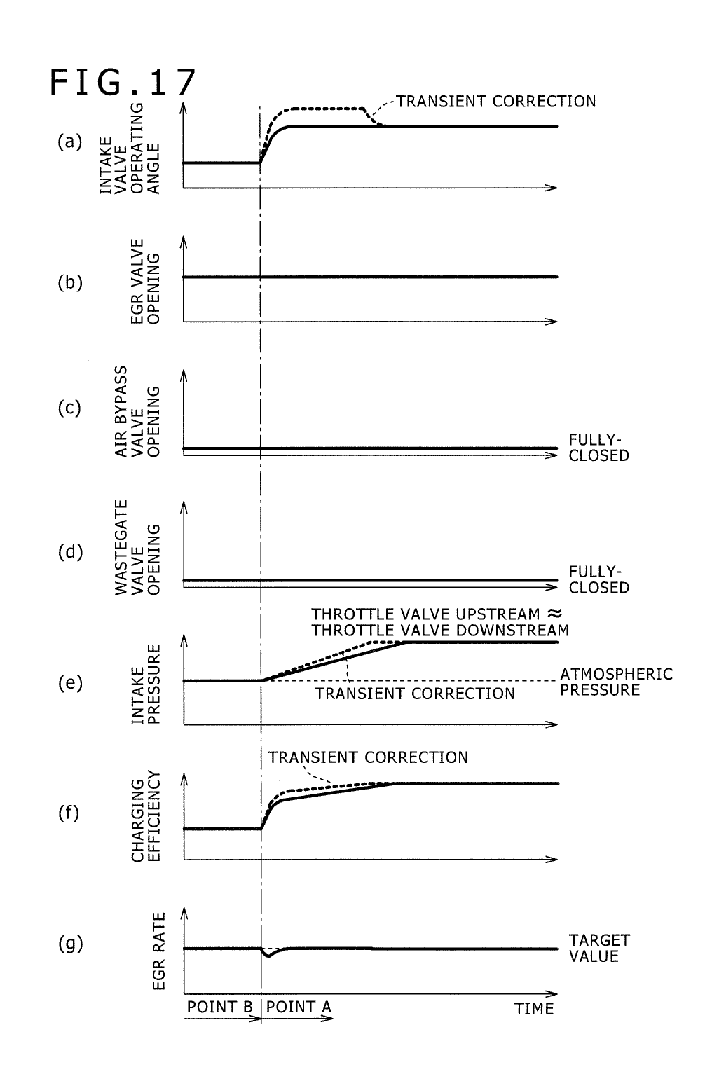

FIG. 16 is a flow chart for describing the respective operation of the intake valve operation angle and wastegate valve when in the supercharging zone and with cooled-EGR supplied, and acceleration is made from the operating point B to the operating point A in the example shown in FIG. 10.

The control blocks shown in FIG. 11 and FIG. 12 execute the (processing for) the flow chart shown in FIG. 16, when a command for executing interrupt processing is input by way of a specified time interruption, the flow chart (processing) shown in FIG. 15 starts up.

When this interrupt is received, an acceleration condition is judged from the driver operating the accelerator pedal, for example from the change in the accelerator (pedal) depression amount per unit of time in step 1601. The processing proceeds to step 1602 and in the current internal combustion engine state the supercharger 3 operates, and a decision is made whether or not the region allows a return flow of exhaust gas. In other words, a decision is made on whether or not the target operating point is in the supercharging zone and moreover within the zone where cooled-EGR is being supplied.

In step 1602, when judged that the target operating point is in the supercharging zone and moreover within the zone where cooled-EGR is supplied, the processing proceeds to step 1603 and the operating angle of the intake valve 12 is increased to increase the intake quantity in order to accelerate, and the processing subsequently proceeds to step 1604 to control the wastegate valve 19. When the wastegate valve 19 was opened in this step 1604, the wastegate valve 19 is closed, and if the wastegate valve 19 was closed, then that closed state is maintained.

The processing next proceeds to step 1605 for control of the air bypass valve 4, and while accelerating the air bypass valve 4 is set to a closed state to allow compressor boost for performing supercharging. In this step 1605, if the air bypass valve 4 was opened, that air bypass valve 4 is closed, and if the air bypass valve 4 was closed, then that closed state is maintained. The spike phenomenon seen during acceleration from a temporary drop in EGR can in this way be prevented.

FIG. 17 is a diagram for describing the time transitions for the operation angle of the intake valve 12, the respective degree of opening of EGR valve 24, air bypass valve 4, and wastegate valve 19, intake pressure, charging efficiency, and EGR rate when accelerated from the operating point B to the operating point A in the example shown in FIG. 10.

When acceleration state is reached, the operating angle of the intake valve 12 is enlarged as shown in FIG. 17(a) to increase the air quantity input to the cylinder, and to increase the torque generated in the internal combustion engine.

The EGR valve 24 is controlled to the specified control degree of opening according to the operating state at this time as shown in FIG. 16(b) and supplies the exhaust gas to the intake flow path 1A.

Also, in order to effectively perform supercharging during acceleration as shown in (c) and (d) of FIG. 17, the turbine rotations are increased by maintaining a state where the air bypass valve 4 and wastegate valve 19 are each closed, and the pressure in the compressor is increased.

By controlling the acceleration through increasing the operating angle of the intake valve 12 in this way, a large difference in before-and-after pressure in the throttle valve 7 as shown in FIG. 17(e) can be prevented. The fluctuations in charging efficiency consequently transition smoothly as shown in FIG. 16(f), a sudden inflow of new air to the downstream section of the throttle valve 7 can be prevented, temporary decreases in exhaust gas during acceleration can be minimized as shown in FIG. 17(g), and the spike phenomenon can be effectively prevented.

When judged here that the intake pressure has not reached the target intake pressure, the acceleration response can be improved by temporarily making a transient correction in the target control quantity to increase side of the intake valve 12 operation angle as shown by the broken lines in FIGS. 17(a), (e), and (f).

### Second Embodiment

In contrast to the above described first embodiment that changed the operating angle of the intake valve 12 or so-called lift quantity in order to control the intake quantity, the other embodiments described hereafter utilize the throttle valve 7 to control the intake quantity.

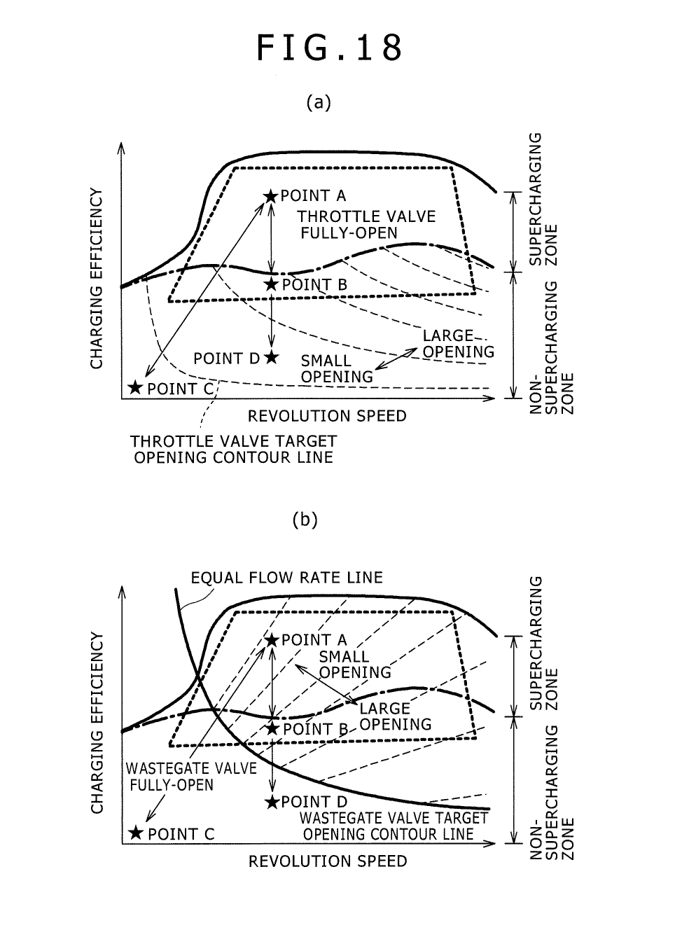

FIG. 18 is a diagram for describing the steady-state target opening map for the throttle valve 7 and the wastegate valve 19 of the internal combustion engine in an internal combustion engine including a supercharger.

FIG. 18(a) shows a steady-state target opening map for the throttle valve 7. In the non-supercharging zone, the degree of opening of the throttle valve 7 is increased along with an increase in the air intake quantity. On the other hand, in the supercharging zone the degree of opening of the throttle valve 7 is set to fully-open to lower the pump loss by utilizing the boost pressure to implement a negative load control.

FIG. 18(b) shows a steady-state target opening map for the wastegate valve 19. The degree of opening of the wastegate valve 19 is set to fully-open when an intake air quantity is at or below a specified value, in order to suppress excessive compression during engine tasks using supercharging. On the other hand, when the intake quantity is a specified value or higher, the charging efficiency lowers, and the degree of opening of the wastegate valve 19 is set to increase as the revolution speed increases.

Implementing this type of control allows reducing pump loss in both supercharging and non-supercharging zones, suppressing a drop in turbine revolution speed, and suppressing the rebound effects that worsen acceleration to a minimum.

In the present embodiment, exhaust gas cooled in the exhaust gas cooler 23 is supplied at a relatively lower load reference level than the supercharging region (region within dashed lines in (a) in the same figure).

The technology of the related art suppressed the exhaust temperature and reduced knocking by fuel enrichment in this region. However, low fuel consumption operation can be achieved by supplying cooled-EGR to reduce knocking and suppress the exhaust temperature in this same region, and also by performing combustion at a stoichiometric air fuel ratio.

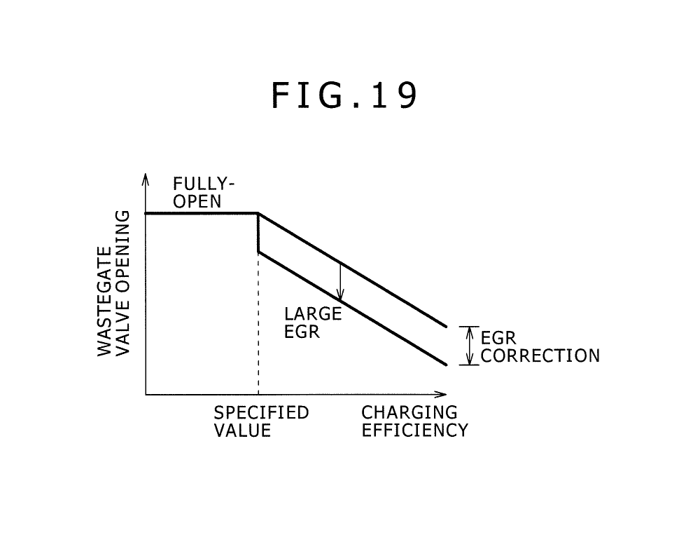

FIG. 19 is a diagram for describing the relation between the charging efficiency and the degree of opening of the wastegate valve 19, and the opening correction amount of the wastegate valve 19 during the supply of exhaust gas. As shown in this same figure, at a charging efficiency set to a specified value or lower, the wastegate valve opening is set to a fully-open state regardless of the size of the charging efficiency, and at a charging efficiency set to a specified value or higher, the wastegate valve opening is set to become smaller the more the charging efficiency increases. Therefore, in order to achieve the same charging efficiency in the present embodiment, correction is required by correcting the degree of opening of the wastegate valve 19 to the reduction side according to the quantity of exhaust gas being supplied.

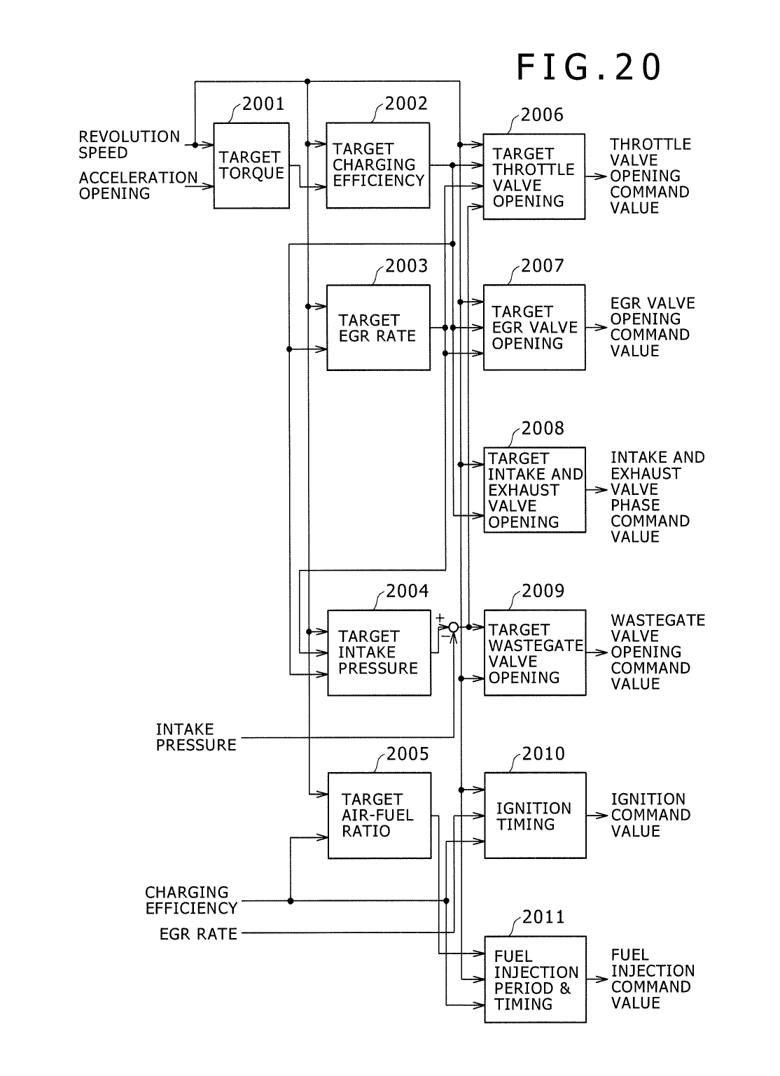

FIG. 20 shows the control block that implements control by way of the ECU 27 the same as in the first embodiment. More specifically, the figure shows a control block for processing the respective control command values for the throttle valve 7, the EGR valve 24, wastegate valve 19, the spark plug 16, and fuel injection valve 11.

In block 2001, the target torque is calculated based on the revolution speed and the acceleration degree-of-opening (pedal depression amount).

In block 2002, the target charging efficiency is calculated based on the revolution speed and the target torque and in block 2003, the target EGR rate is calculated based on the revolution speed and the target charging efficiency.

In block 2004, the target intake pipe pressure is calculated based on the revolution speed, the target charging efficiency, and the target EGR rate; and in block 2005, the target air-fuel ratio is calculated based on the revolution speed and charging efficiency.

In block 2006, the degree of opening of the target throttle valve is calculated based on the revolution speed, the target charging efficiency, the target EGR rate, and the difference between the target intake pressure and the current intake pressure.

In block 2007, the degree of opening of the target EGR valve is calculated based on the revolution speed, the target charging efficiency, and the target EGR rate.

In block 2008, the phase of the target intake-exhaust valve is calculated based on the revolution speed and target charging efficiency. In block 2009, the degree of opening of the target wastegate valve is calculated based on the revolution speed and the difference between the target intake pressure and the current intake pressure. In block 2010, the ignition timing is calculated based on the revolution speed, the current charging efficiency, and the current EGR rate, and in block 2011 the fuel injection period and the fuel injection timing is calculated based on the revolution speed, the current charging efficiency, and the target air-fuel ratio.

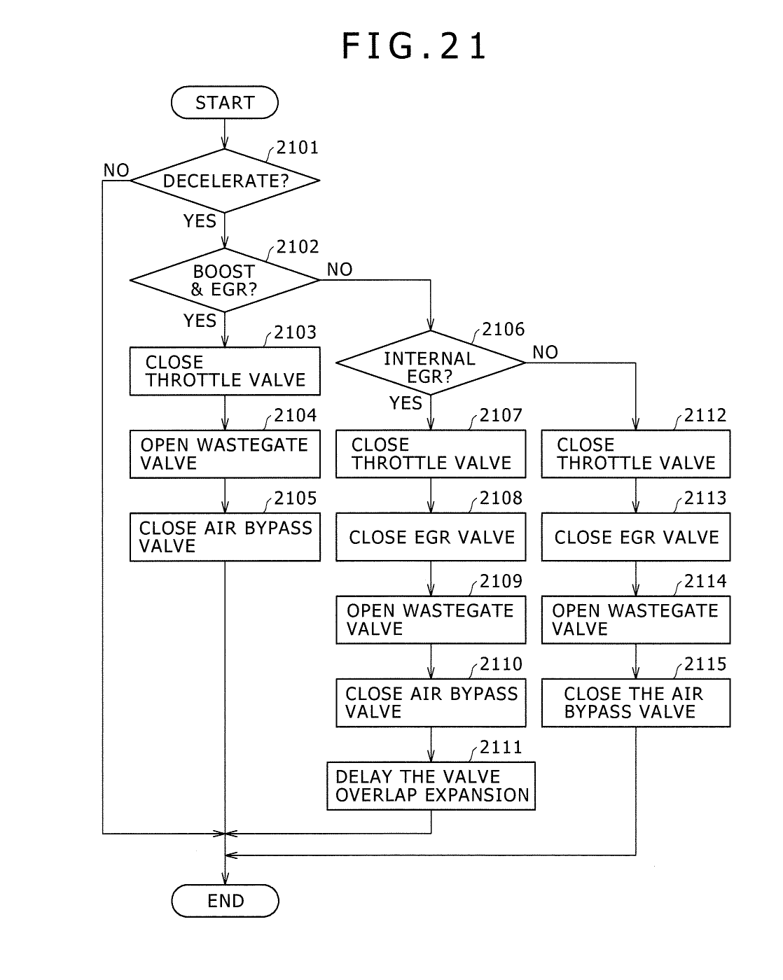

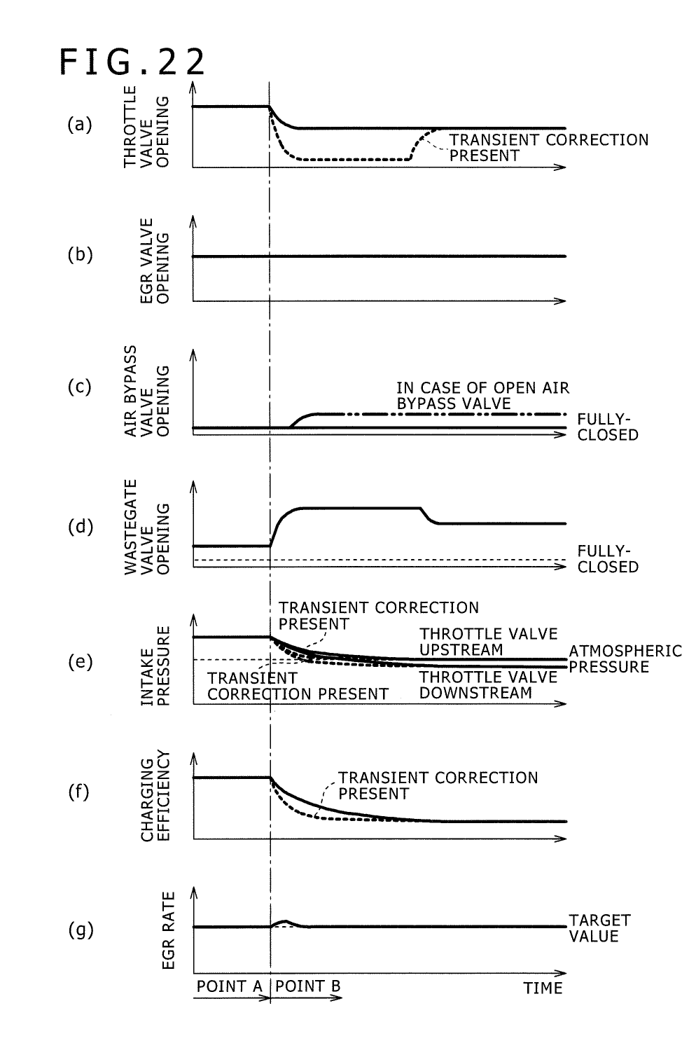

FIG. 21 is a flow chart for describing the control operation of throttle valve 7, EGR valve 24, air bypass valve 4, wastegate valve 19, intake valve 12, and exhaust valve 14 when in the supercharging zone and with cooled-EGR supplied when decelerating from the operating point B to the operating point C in the example in FIG. 18.

In FIG. 21, decelerating condition is judged to have occurred due to the driver operating the accelerator pedal in step 2101, the same as in the first embodiment; and in step 2102 a judgment is made on whether or not the target operating point is in the supercharging region and also in the region where cooled-EGR is supplied.

When judged in this step 2102 as within the supercharging region and also in the region where cooled-EGR is supplied, the processing proceeds to step 2103 and the throttle valve 7 is closed, and next in step 2104 the wastegate valve 19 is opened, and further in step 2105, the air bypass valve 4 is closed.

The above operation in this way prevents the spike phenomenon that the EGR is temporarily increased observed during deceleration.

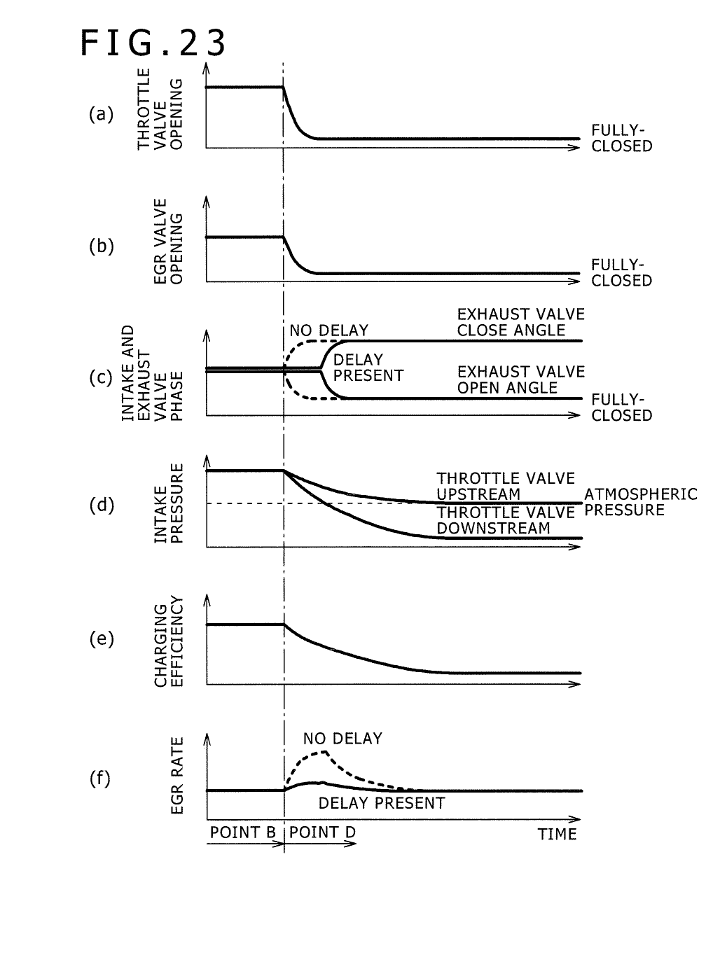

FIG. 22 is a diagram for describing the time transitions for the respective degree of opening of throttle valve 7, EGR valve 24, air bypass valve 4, and wastegate valve 19, intake pressure, charging efficiency and EGR rate controlled as shown in step 2103 through step 2105 when decelerated from the operating point A to operating point B, in the example in FIG. 18.

Along with performing deceleration control by reducing the degree of opening of the throttle valve 7 as shown in FIG. 22(a), the air bypass valve 4 is set to a closed state as shown in FIGS. 22(c) and (d), and the wastegate valve 19 is set to be opened. Here, this region is a region for performing EGR so the EGR valve is in an opened state as shown in FIG. 22(b).

There is therefore no true significant difference between the before-and-after intake pressure of the throttle valve 7 as seen in FIG. 22(e), the charging efficiency smoothly decreases as in FIG. 22(f), and consequently the EGR rate can also stabilize with no large fluctuation as shown in FIG. 22(g).

The return flow of EGR to the upstream section of the compressor can in this way be prevented by setting the air bypass valve 4 to the closed state during deceleration. Also, the spike phenomenon occurring due to a temporary increase in exhaust gas during deceleration as described in the example of the related art in FIG. 5 can be appropriately prevented.

Also, the turbine revolution speed can be limited by opening the wastegate valve 19 to allow preventing the surging reduction that occurs during an excessive rise in boost pressure under low intake flow rate conditions of the intake quantity.

Moreover, the surging can be prevented even more thoroughly by slightly opening the air bypass valve 4 to an extent where the flow does not reach the upstream side of the EGR convergence section due to the reverse flow of exhaust gas, after at least a specified time after the start of the wastegate valve 19 operation, as shown by the two-dot chain line in FIG. 22(c).

Further, when judged here that the intake pressure has not reached the target intake pressure, the deceleration response can be improved by making a transient correction to temporarily decrease (to the lower side) the target control quantity for the intake valve operation angle as shown by the broken lines in FIGS. 22(a), (e), and (f).

Returning to FIG. 21, when judged in this step 2102 as within the supercharging region and also in the region where cooled-EGR is supplied, the processing proceeds to step 2106, and a judgment is made whether or not the operating point serving as the target is within the range for supplying internal EGR, by the phase varying mechanism utilizing intake valve 12 and exhaust valve 14.

When judged in step 2106 that the region is for performing internal EGR, the processing proceeds to step 2107 and the throttle valve 7 is closed. Since judged in step 2102 that the region is not within the EGR range, control is implemented in step 2108 to close the EGR valve 24.

Following the above steps, the wastegate valve 19 is opened in step 2109, and next the air bypass valve 4 is closed in step 2110, and further in step 2111 the expanded operation of the intake valve 12 and exhaust valve 14 for an overlap (O/L) period by the phase varying mechanism is delayed until a specified number of cycles have elapsed. The supply of a large quantity of EGR due to the superimposition of internal EGR and cooled-EGR accumulated within the intake manifold can in this way be prevented.

FIG. 23 is a diagram for describing the time transitions for the degree of opening of throttle valve 7 and EGR valve 24, intake valve phase, intake pressure, charging efficiency, and EGR rate by the control shown step 2107 through step 2111 when decelerating from operating point A to operating point Din the example in FIG. 18. The degree of opening of the wastegate valve 19 and the air bypass valve 4 were omitted here however the same operation as in FIGS. 22(c) and (d) maybe implemented.

When the throttle valve 7 suddenly stops due to deceleration, the intake air in the compressor downstream section (throttle valve upstream section) has no place to go so the boost pressure suddenly starts to rise as described in the first embodiment. The air bypass valve 4 starts to open when the difference in before and after pressure in the throttle valve 7 becomes large, and gas containing EGR flows in reverse from the compressor downstream section to the upstream section.

Even in cases when the EGR valve 24 suddenly stops as shown in FIG. 23(b) in synchronization with sudden stop of the throttle valve 7 as shown in FIG. 23(a), there is a fixed delay until the EGR accumulated in the space from a downstream section of the EGR convergence section to the cylinders reaches the cylinders. The percentage of internal EGR within the cylinders here increases when the overlap period of the intake valve 12 and the exhaust valve 14 is increased in synchronization with the closing action of the throttle valve 7. The superimposing of the accumulated EGR on the internal EGR, supplies a large quantity of EGR in the cylinders, consequently causing the problem of misfires to occur.

As a countermeasure, by adding step 2111, and by delaying the timing to expand the intake valve 12 and exhaust valve 14 overlap as shown in FIG. 23(c) in the period from the stop timing of throttle valve 7 until a specified (number) of cycles has elapsed, misfires can be prevented by providing a large EGR quantity as shown in FIG. 23(f).

Here, in FIGS. 23(c) and (f), the broken line shows the case where the timing to expand the overlap of the intake valve 12 and exhaust valve 14 is in synchronization with the stop timing of the throttle valve 7. The solid line shows the case where the timing to expand the overlap of the intake valve 12 and exhaust valve 14 is delayed for a period from the stop timing of the throttle valve 7 until a specified number of cycles is elapsed.

Returning to FIG. 21, when judged in step 2106 that the target operating point is not within the region where internal EGR is supplied, the processing proceeds to step 2112 and operation is implemented so that the throttle valve 7 is closed, and next in step 2113, the EGR valve 24 is closed, and subsequently in step 1224, the wastegate valve 19 is opened, and finally in step 2115 the air bypass valve 4 is closed.

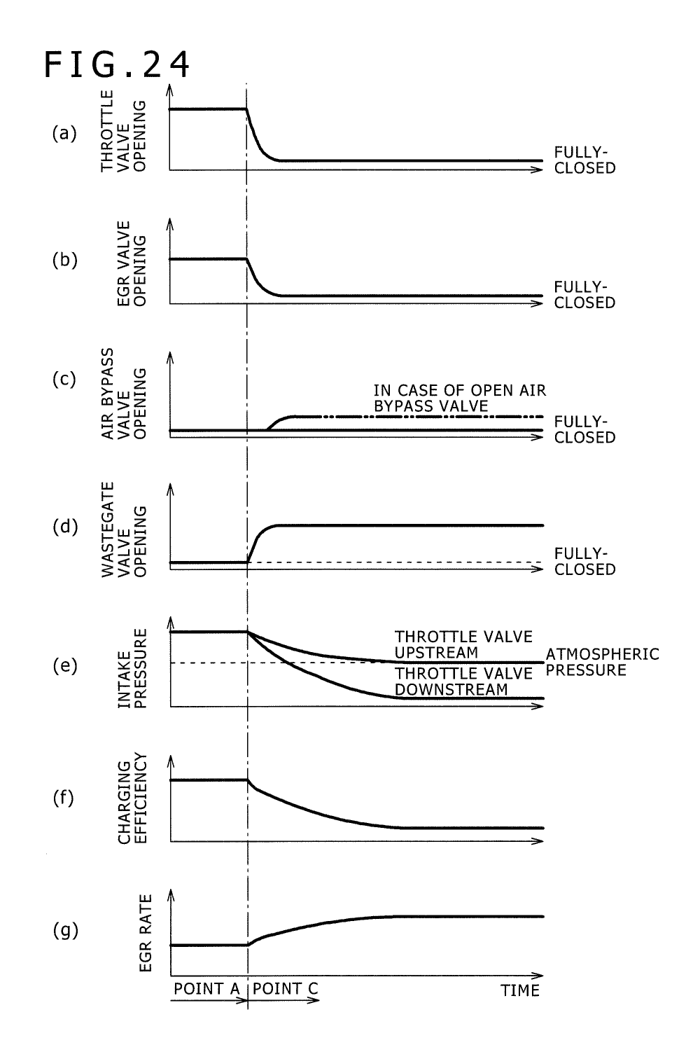

FIG. 24 is a diagram for describing the time transitions for the degree of openings of throttle valve 7, EGR valve 24, air bypass valve 4, wastegate valve 19, intake pressure, charging efficiency, and EGR rate by the control shown in step 2112 through step 2115 when decelerated from the operating point A to the operating point C in the example in FIG. 18.

During a sudden stop by closing of the throttle valve 7 as shown in FIG. 24(a), the EGR valve 24 is closed from the control state as shown in FIG. 24(b), and further the wastegate valve 19 is opened as shown in FIG. 24(d) and the air bypass valve 4 is in a closed state as shown in FIG. 24(c).

The return flow of exhaust gas to the upstream section of the compressor can in this way be prevented by setting the air bypass valve 4 to the closed state. Also, as seen in FIG. 24(g), the spike phenomenon occurring due to a temporary increase in exhaust gas during deceleration as described in FIG. 5 can be appropriately prevented.

The surging can be even more thoroughly prevented by slightly opening the air bypass valve 4 to an extent where the flow does not reach the upstream side of the EGR convergence section caused by a reverse flow of exhaust gas after at least a specified time after the start of the wastegate valve 19 operation, as shown by the two-dot chain line in FIG. 24(c).

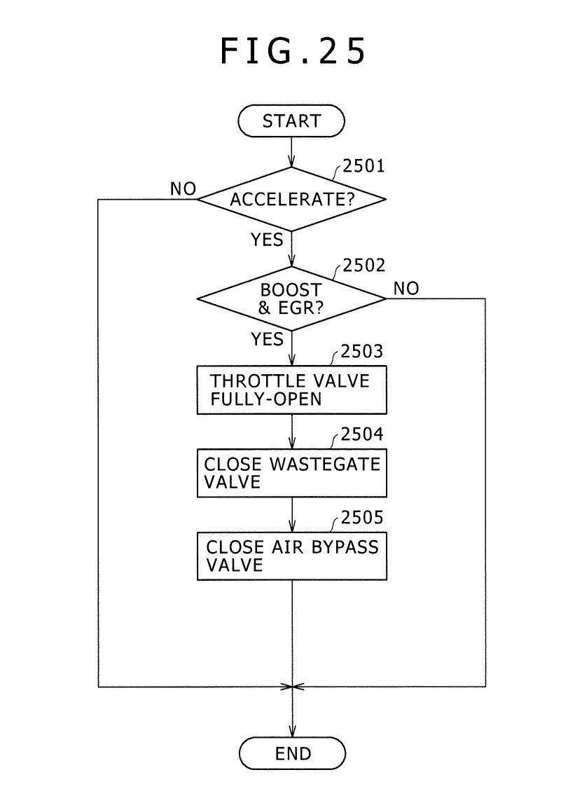

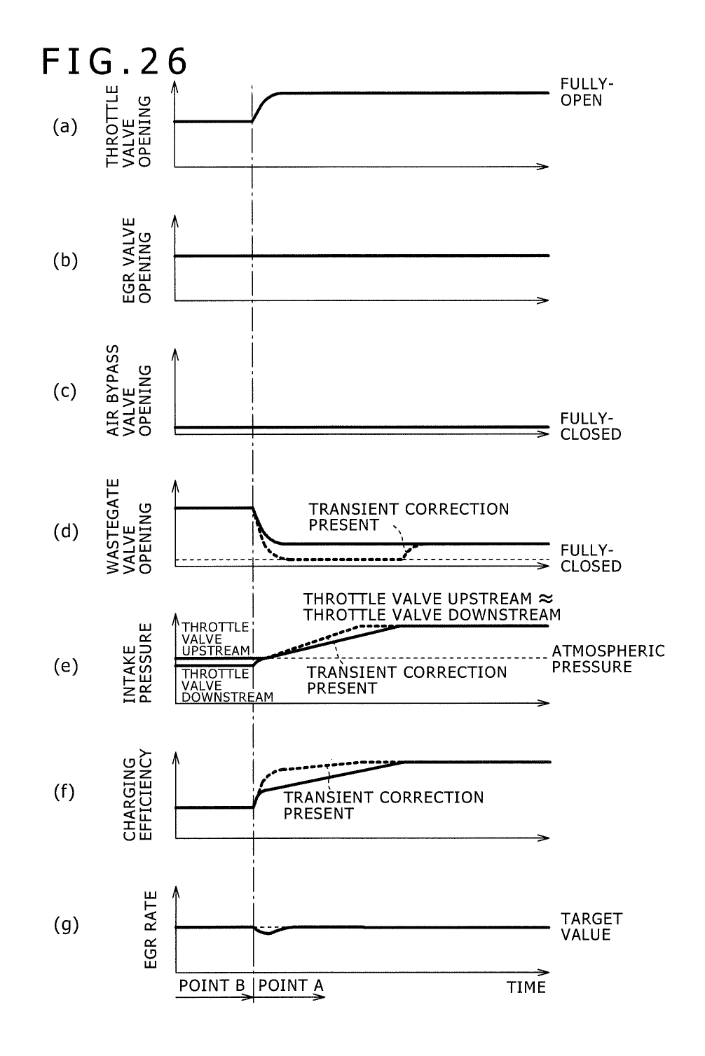

FIG. 25 is a flow chart for describing the control operation of the throttle valve and wastegate valve when in the supercharging zone and with cooled-EGR supplied when accelerated from the operating point B to the operating point A in the example in FIG. 18.

In FIG. 25, an accelerating condition is judged to have occurred due to the driver operating the accelerator pedal in step 2501; and the processing proceeds to step 2501 and a judgment is made on whether or not within the supercharging zone and also in the region where cooled-EGR is supplied. When decided in step 2502 that the operation state is in the supercharging zone and the region where cooled-EGR is supplied, the processing proceeds to step 2503 and the throttle valve 7 is opened.

After the above steps, the operation is controlled so that the wastegate valve 19 is closed in step 2504, and the air bypass valve 4 is closed in step 2505.

The above operation in this way prevents the spike phenomenon that is observed when the exhaust gas is temporarily decreased during acceleration.

FIG. 26 is a diagram for describing the time transitions for the degree of opening of the throttle valve 7, EGR valve 24, air bypass valve 4, and wastegate valve 19, intake pressure, charging efficiency, and EGR rate when accelerated from the operating point B to the operating point A in the example in FIG. 18.

When the throttle valve 7 is opened as shown in FIG. 26(a), the EGR valve 24 is controlled to the control degree of opening specified in FIG. 26(b) since the EGR valve 24 is in the EGR zone. At this time, the air bypass valve 4 is closed as shown in FIG. 26(c), FIG. 26(d) in order to maintain acceleration performance, and the wastegate valve 19 is also closed. Here, the before-and-after the intake pressure in the throttle valve 7 is nearly the same values as shown in FIG. 26(e). The charging efficiency also therefore has a smooth transition as shown in FIG. 26(f). Consequently, the temporary decrease in exhaust gas during acceleration can be reduced as shown in FIG. 26(g), and the spike phenomenon can be effectively prevented.

Opening the wastegate valve 19 at the operating point B serves to eliminate excess operation by the supercharger, so that the before-and-after difference in pressure of the throttle valve 7 can be reduced as compared to the control of the related art that closes the wastegate valve 19 at the same operating point B.

Consequently, the sudden inflow of new air to the downstream section of the throttle valve 7 can be suppressed, and the spike phenomenon that occurred due to a temporary decrease in exhaust gas during the acceleration as described in FIG. 4 can be effectively prevented. Also, when judged that the intake pressure has not reached the target intake pressure, the acceleration response can be improved by temporarily making a transient correction to the closed side of the wastegate valve 19 as shown by the dashed line.

The unique effects rendered by the first embodiment and the second embodiment are described next.

(1) In internal combustion engines in a supercharged state, and in a state with a return flow of EGR, during deceleration where gas inflow to the cylinders is reduced by an intake quantity control means, opening the wastegate valve with the air bypass valve in a closed state, renders the effect of preventing spikes in the EGR, and besides suppressing the torque fluctuations and deterioration in the exhaust that accompany fluctuations in the air-fuel ratio, can also prevent misfires caused by an excessive EGR supply. Also, opening the wastegate valve can prevent the surging observed at a low flow rate and during high boost pressure.

(2) Utilizing a variable valve to vary the phase and operating angle of the intake valve by the intake quantity control means, can suppress the before-and-after pressure differences occurring in the throttle valve, and can also prevent EGR spikes accompanying the reverse flow from the air bypass valve observed during decelerating, as well as the EGR spikes that accompany the sudden inflow of new air to downstream of the throttle valve observed during accelerating.

(3) In internal combustion engines in a supercharged state, and in a state with a return EGR flow, when increasing the intake quantity flowing into the cylinders, closing the wastegate valve with the throttle valve in a fully-open state allows preventing EGR spikes accompanying the sudden inflow of new air to downstream of the throttle valve observed during accelerating.

(4) In internal combustion engines in a supercharged state, and in a state with a return EGR flow, when decreasing the intake quantity flowing into the cylinders, opening the wastegate valve with the air bypass valve in a closed state allows preventing EGR spikes accompanying the reverse flow from the air bypass valve observed during decelerating.

(5) When reducing the quantity of gas flowing into the cylinders by utilizing the intake quantity control means, by slightly opening the air bypass valve at a timing at least from the opening of the wastegate valve onwards, to an extent where the reverse flow of EGR does not reach the upstream flow side of the EGR convergence section; the EGR spike can be suppressed, and the surging observed during a low flow rate and during high boost pressure can be even more securely prevented.

(6) In internal combustion engines in a supercharged state, and in a state with a return EGR flow, setting the degree of opening of the wastegate valve to decrease, the more the EGR rate increases, while at the same charging efficiency, allows controlling the charging efficiency with good accuracy and lowering the pump loss even in a state with EGR return flow, and low fuel consumption operation can be achieved by combustion at a stoichiometric air fuel ratio.

(7) In internal combustion engines in a supercharged state, when reducing the gas quantity flowing into the cylinders by way of the intake quantity control means from a supercharged state and with a return EGR flow, towards a state where enlarging the intake-exhaust valve overlap period with an increase in the internal EGR quantity while in a non-supercharged state; by delaying the timing for expanding the intake-exhaust valve overlap period by a specified number of cycles, and by superimposing the internal EGR due to expansion of the overlap (timing) with EGR accumulated downstream from the EGR convergence section, the misfires caused by a large quantity of EGR within the cylinders can be prevented.

### LIST OF REFERENCE SIGNS

1 . . . Internal combustion engine, 2 . . . Air flow sensor and intake temperature sensor, 3 . . . Turbocharger, 4 . . . Air bypass valve, 5 . . . Intercooler, 6 . . . Temperature sensor, 7 . . . Throttle valve, 8 . . . Intake manifold, 9 . . . Pressure sensor, 10 . . . Flow strengthening valve, 11 . . . Fuel injection valve, 12 . . . Intake varying valve mechanism, 13 . . . Intake varying valve mechanism, 14 . . . Exhaust varying valve mechanism, 15 . . . Exhaust varying position sensor, 16 . . . Spark plug, 17 . . . Knock sensor, 18 . . . Crank angle sensor, 19 . . . Wastegate valve, 20 . . . Air-fuel sensor, 21 . . . Exhaust cleansing catalyst, 22 . . . EGR pipe, 23 . . . EGR cooler, 24 . . . EGR valve, 25 . . . Temperature sensor, 26 . . . Differential sensor, and 27 . . . ECU (Electronic Control Unit)

1. A control device for an internal combustion engine comprising:
an exhaust side turbine mounted on the exhaust path;
a wastegate valve mounted on the bypass path joining the upstream side and the downstream side of the exhaust side turbine;
an intake side compressor mounted on the intake flow path and driven by the exhaust side turbine;
an air bypass valve mounted on the bypass path joining the upstream side and downstream side of the intake side compressor;
an exhaust gas return flow path to return the exhaust gas from the exhaust flow path to the intake flow path upstream of the intake side compressor;
an exhaust gas return flow control valve mounted on the exhaust gas return flow path; and
a control means utilized in an internal combustion engine containing an intake quantity control means that controls the intake quantity flowing on the intake flow path, and controls at least the operation of the wastegate valve, the exhaust gas return flow control valve, and the intake quantity control means,
wherein in an operating state where both supercharged by the intake side compressor and where exhaust gas is returned from the exhaust gas return flow path, the control means sends a control signal to the wastegate valve in a state where the air bypass valve is closed during supercharging operation when the intake quantity is increased or decreased by the intake quantity control means.

2. The control device for an internal combustion engine according to claim 1,
wherein during decelerating operation when the intake quantity is decreased by the intake control means, the control means sends a control signal to the wastegate valve so that the wastegate valve is opened in a state where the air bypass valve is closed.

3. The control device for an internal combustion engine according to claim 1, comprising:
a control means that controls the operation of the air bypass valve,
wherein during decelerating operation when the intake quantity is decreased by the intake control means, the control means sends a control signal to the air bypass valve and the wastegate valve so that the wastegate valve is opened and the air bypass valve is closed.

4. The control device for an internal combustion engine according to claim 1,
wherein in an operating state where both supercharged by the intake side compressor and where exhaust gas is returned from the exhaust gas return flow path, when decreasing the intake quantity, the control means sends a control signal to the wastegate valve so that the wastegate valve is opened in a state where the air bypass valve is closed; and also sends either a control signal to close the exhaust gas return control valve or a control signal to open the exhaust gas return flow control valve, to the exhaust gas return flow control valve.

5. The control device for an internal combustion engine according to claim 4,
wherein the control means sends a control signal to the exhaust gas return flow control valve to close the exhaust gas return flow control valve when the operating state to shift to is not both an operating state where supercharged by the intake side compressor and where exhaust gas is returned from the exhaust gas return flow path; and the control means sends a control signal to open the exhaust gas return flow control valve to the exhaust gas return flow control valve when the operating state to shift to is both an operating state where supercharged by the intake side compressor and where exhaust gas is returned from the exhaust gas return flow path.

6. The control device for an internal combustion engine according to claim 5,
wherein when the operating state to shift to is not both an operating state where supercharged by the intake side compressor and where exhaust gas is returned from the exhaust gas return flow path; and furthermore requires internal EGR; the control means sends a control signal to close the exhaust gas return flow control valve to the exhaust gas return flow control valve, and also sends a control signal for expanding the valve overlap of the intake valve and exhaust valve, and for delaying this expanded period for a specified time to the phase varying mechanism of the intake valve and the exhaust valve.

7. The control device for an internal combustion engine according to claim 5,
wherein when the operating state to shift to is not both an operating state where supercharged by the intake side compressor and where exhaust gas is returned from the exhaust gas return flow path; and furthermore requires internal EGR; the control means sends a control signal to close the exhaust gas return flow control valve to the exhaust gas return flow control valve, and also sends a control signal for expanding the cylinder volume for the period where the exhaust valve is closed, and for delaying this expanded period for a specified time, to the phase varying mechanism of the exhaust valve.

8. The control device for an internal combustion engine according to claim 6,
wherein when the operating state to switch to is not both an operating state where supercharged by the intake side compressor and where exhaust gas is returned from the exhaust gas return flow path; and furthermore does not require internal EGR; the control means sends a control signal to close the exhaust gas return flow control valve to the exhaust gas return flow control valve, and also sends a control signal to the air bypass valve and the wastegate valve so that the air bypass valve is closed and the wastegate valve is opened.

9. The control device for an internal combustion engine according to claim 1,
wherein the intake quantity control means is a lift and phase varying mechanism that varies the phase and the operating angle of the intake valve or is a throttle valve mounted in the intake flow path.

10. The control device for an internal combustion engine according to claim 3,
wherein in an operating state where both supercharged by the intake side compressor and where exhaust gas is returned from the exhaust gas return flow path, when decreasing the intake quantity, the control means sends a control signal to the air bypass valve and the wastegate valve so that the air bypass valve is closed and the wastegate valve is opened, and also sends a control signal that opens the air bypass valve by just a specified amount after the wastegate valve is opened, at a timing after the wastegate valve is opened.

11. The control device for an internal combustion engine according to claim 1,
wherein in an operating state where both supercharged by the intake side compressor and where exhaust gas is returned from the exhaust gas return flow path, during accelerating operation when the intake quantity is increased, the control means sends a control signal to the wastegate valve so that the wastegate valve is closed in a state where the air bypass valve is closed, and also sends a control signal to set the exhaust gas return flow control valve to an opened state, to the exhaust gas return flow control valve.

12. The control device for an internal combustion engine according to claim 11,
wherein when increasing the intake quantity, the control means sends a control signal to fully open the throttle valve to the throttle valve, and in this state sends a control signal to the wastegate valve so that the wastegate valve is closed in a state where the air bypass valve is closed.

13. The control device for an internal combustion engine according to claim 11,
wherein in order to increase the intake quantity, the control means sends a control signal to the lift and phase varying mechanism to increase the intake quantity by way of the lift and phase varying mechanism.

14. The control device for an internal combustion engine according to claim 11,
wherein the control means sends a control signal to decrease the degree of opening of the wastegate valve along with the increase in the EGR rate at the same charging efficiency to the wastegate valve.
